(19) United States
(12) Patent Application Publication
(10) Pub. No.: US 2012/0311596 A1
(43) Pub. Date: Dec. 6, 2012

(54) INFORMATION PROCESSING APPARATUS, COMPUTER-READABLE STORAGE MEDIUM HAVING STORED THEREIN INFORMATION PROCESSING PROGRAM, INFORMATION PROCESSING METHOD, AND INFORMATION PROCESSING SYSTEM

(75) Inventors: Daiji IMAI, Kyoto (JP); Hisashi Koyama, Kyoto (JP)

(73) Assignee: NINTENDO CO., LTD., Kyoto (JP)

(21) Appl. No.: 13/210,680

(22) Filed: Aug. 16, 2011

(30) Foreign Application Priority Data
Jun. 3, 2011 (JP) 2011-125537

(51) Int. Cl. G06F 9/46

(52) U.S. Cl. 718/103

(57) ABSTRACT

A program reception task and an advertisement reception task are set. The program reception task defines an execution content which includes an execution schedule of a reception process for program data including video data and audio data of programs, and the advertisement reception task defines an execution content including an execution schedule of a reception process for advertisement data including at least one of video data, still image data, and audio data of advertisements. Then, the program reception task and the advertisement reception task are executed based on the execution schedules set in the program reception task and the advertisement reception task, respectively, to perform reception of the program data and reception of the advertisement data from a server independently from each other.

### CROSS REFERENCE TO RELATED APPLICATION

The disclosure of Japanese Patent Application No. 2011-125537, filed on Jun. 3, 2011, is incorporated herein by reference.

### BACKGROUND OF THE INVENTION

1. Field of the Invention

The present invention relates to information processing for distributing programs, and more particularly, information processing for receiving and reproducing distributed programs.

2. Description of the Background Art

Conventionally, systems for providing videos and advertisements have been known (for example, Japanese Laid-Open Patent Publication No. 2001-309328). In the conventional system, a transmitter device transmits a multiplexed signal in which video and audio data of a program and advertisement data are multiplexed with information data including program information and advertisement information, and a receiver device demultiplexes the received multiplexed signal and outputs the demultiplexed signals.

In the system disclosed in Laid-Open Patent Publication No. 2001-309328, however, the receiver device requires demultiplexing means for demultiplexing the received multiplexed signal. Further, since a program and an advertisement are multiplexed and transmitted, the amount of data to be transmitted at one time is increased, resulting in a problem that the data strains on the network. For example, when a program and an advertisement are multiplexed (i.e., integrated) and transmitted, if the same advertisement is used in different programs, data of the same advertisement might be included in each of multiplexed signals of the different programs. That is, data of the same advertisement might be transmitted redundantly, which causes a strain on the network.

### SUMMARY OF THE INVENTION

Therefore, an object of the present invention is to provide an information processing apparatus, a computer-readable storage medium having stored therein an information processing program, an information processing method, and an information processing system, which are novel.

Another object of the present invention is to provide an information processing apparatus, a computer-readable storage medium having stored therein an information processing program, an information processing method, and an information processing system, which are capable of executing reception of a video and reception of an advertisement independently from each other.

The present invention has the following features to attain the object mentioned above.

An information processing apparatus according to an aspect of the present invention includes task setting means, connection means, and task execution means. The task setting means sets a program reception task and an advertisement reception task. The program reception task defines an execution content which includes an execution schedule of a reception process for program data including video and audio data of programs, and the advertisement reception task defines an execution content which includes an execution schedule of a reception process for advertisement data including at least one of video data, still image data, and audio data of advertisements. The connection means connects the information processing apparatus to a server. The task execution means executes the program reception task and the advertisement reception task, based on the execution schedules which are set in the program reception task and the advertisement reception task, respectively, thereby executing reception of the program data and reception of the advertisement data from the server independently from each other.

According to the above configuration, the amount of data required for one reception process is reduced, and a processing load related to reception can be dispersed. Thereby, for example, parallel processing can be realized, in which reception of programs and advertisements is performed as a background process when an application is being executed. Further, since the amount of data is reduced, a connection time required for one data reception can be shortened. Thereby, the present invention is particularly suitable for an information processing terminal for which constant connection is not ensured, such as a hand-held information processing terminal which is connected to a server via a public access point by using short-distance wireless communication.

In an alternatively configuration, each of the execution schedules includes at least one of the execution interval of the reception process, the priority thereof, and the number of times thereof, and the execution schedule of the program reception task and the execution schedule of the advertisement reception task are different from each other.

According to the above configuration, reception of program data and reception of advertisement data are executed at different intervals, priorities, and numbers of times. Therefore, a processing load on a network related to the reception process can be appropriately dispersed.

In an alternatively configuration, the task setting means sets an update task which represents an execution schedule of a reception process for update data for updating the execution schedules of the program reception task and the advertisement reception task. The task execution means executes the update task to update the execution schedule of at least one of the program reception task, the advertisement reception task, and the update task, based on the update data received from the server.

According to the above configuration, the task execution schedule can be flexibly varied.

In an alternatively configuration, the task setting means sets a plurality of program reception tasks. The task execution means executes the plurality of program reception tasks to perform receptions of a plurality of program data independently from each other.

According to the above configuration, reception of the plurality of programs are executed by the plurality of tasks. Therefore, the reception schedules of the respective programs can be flexibly set. For example, the respective programs can be received independently from each other, in accordance with the types of the programs, the creators of the programs, or the like.

In an alternatively configuration, the information processing apparatus further includes application execution means for executing an application for playing the program data. The application execution means, when executing an application, automatically plays the program data received by the task execution means.

According to the above configuration, the received program is presented to the user when the application is started, and thereby the user is prompted to view the program.

In an alternative configuration, the information processing apparatus further includes program playback information setting means for setting program playback information indicating whether or not there is a playback record of the program data. The application execution means, when executing an application, automatically plays the program data which is indicated as being unplayed by the program playback information.

According to the above-configuration, a program, which has not yet been viewed by the viewer, is automatically presented to the user without an operation by the user. Therefore, the program can be viewed by the user more reliably.

In an alternative configuration, the task setting means sets a plurality of program reception tasks corresponding to program data provided from a plurality of creators. The task execution means executes the plurality of program reception tasks to independently perform receptions of a plurality of program data provided from the plurality of creators. When there are a plurality of program data created by a plurality of creators, which are indicated as being unplayed by the program playback information, the application execution means automatically plays the plurality of unplayed program data in accordance with a predetermined order.

According to the above configuration, the programs from the plurality of creators can be received independently from each other, and automatically presented to the user in the predetermined order.

In an alternative configuration, the information processing apparatus further includes: counting means for counting a time; application startup time obtaining means for obtaining a startup time when the application is executed; and order determination means for determining program data of a creator, which is to be played first in the predetermined order, based on the time obtained by the application startup time obtaining means.

According to the above configuration, among the unplayed programs, a program of a creator, which is to be played first, can be fairly determined.

In an alternative configuration, the order determination means determines a predetermined order such that two or more programs from the same creator are not played continuously.

According to the above configuration, the playback order of the programs supplied from the plurality of creators can be fairly determined.

In an alternative configuration, the application execution means outputs, to a display section, a program video based on the program data and an advertisement based on the advertisement data. The information processing apparatus further includes: viewing information creation means for creating viewing record information indicating a viewing record of the program and a viewing record of the advertisement, in response to that the program and the advertisement are outputted to the display section; and viewing information transmission means for transmitting, to the server, the viewing record information created by the viewing information creation means.

According to the above configuration, the user's viewing status with respect to each program or advertisement can be known.

In an alternative configuration, the task execution means executes the advertisement reception task to receive a plurality of advertisement data from the server. The application execution means plays the program data, and displays, on a predetermined display section, advertisements based on the advertisement data. The information processing apparatus further includes advertisement selection means for selecting, based on predetermined conditions, the advertisements to be displayed on the display section.

According to the above configuration, an advertisement can be displayed simultaneously with playback of a program.

In an alternative configuration, the advertisement selection means selects at random the advertisements to be displayed on the display section.

According to the above configuration, a plurality of advertisements are provided with equal opportunities for display.

In an alternative configuration, the information processing apparatus further includes advertisement playback information setting means for setting advertisement playback information indicating whether or not there is a playback record of the advertisement data. The advertisement selection means selects advertisements to be displayed on the display section from among advertisements which are indicated as being unplayed by the advertisement playback information.

According to the above configuration, unviewed advertisements can be preferentially displayed, and thereby the respective advertisements are provided with equal opportunities for viewing.

In an alternative configuration, the information processing apparatus further includes: input reception means for receiving an input from a user; instruction determination means for determining, based on the input received by the input reception means, whether or not the user designates an advertisement displayed on the display section based on the still image data; and web site connection means for connecting the information processing apparatus to a web site linked to the still image data, when the instruction determination means determines that the user designates an advertisement.

According to the above configuration, the user is notified of presence of a web site linked to a still-image advertisement. If the user is interested in the advertisement, the user can quickly access the web site.

In an alternative configuration, the task execution means automatically executes the program reception task and the advertisement reception task as background processes. The application execution means executes the application for playing the program data, as a foreground process, in accordance with user's instruction, and automatically outputs, when it is started, the program data and the advertisement data which have been received in the background by the task execution means.

According to the above configuration, a program or advertisement is received before the user knows it, and thereafter, presented to the user at a predetermined timing. Therefore, the program or advertisement can surprise and please the user.

In an another configuration, the information processing apparatus further includes searching means for automatically and repeatedly searching for a predetermined access point by using short-distance wireless communication. When the searching means detects the access point, the connection means automatically connects the information processing apparatus to the server via the access point.

According to the above configuration, even a hand-held information terminal, which has only a function of short-distance wireless communication and is difficult to be constantly connected because it is supposed to be carried, automatically and repeatedly searches for an access point. Therefore, it is possible to provide a hand-held information terminal having a mechanism close to constant connection.

In an another configuration, the task setting means sets the execution schedules such that the execution interval of the advertisement reception task is shorter than that of the program reception task, the priority of the advertisement reception task is higher than that of the program reception task, and the number of times of execution of the advertisement reception task is greater than that of the program reception task.

According to the above configuration, it is possible to set more advertisement reception opportunities than program reception opportunities. Therefore, more advertisements can be presented to the user.

An information processing program according to the present invention is an information processing program to be executed by a computer of an information processing apparatus, and the information processing program causes the computer to function as; task setting means, connection means, and task execution means. The task setting means sets a program reception task and an advertisement reception task. The program reception task defines an execution content which includes an execution schedule of a reception process for program data including video and audio data of programs, and the advertisement reception task defines an execution content which includes an execution schedule of a reception process for advertisement data including at least one of video data, still image data, and audio data of advertisements. The connection means connects the information processing apparatus to a server. The task execution means executes the program reception task and the advertisement reception task, based on the execution schedules which are set in the program reception task and the advertisement reception task, respectively, thereby executing reception of the program data and reception of the advertisement data from the server independently from each other.

An information processing method according to the present invention, which is executed by an information processing apparatus, includes a task setting step, a connection step, and a task execution step. The task setting step sets a program reception task and an advertisement reception task. The program reception task defines an execution content which includes an execution schedule of a reception process for program data including video and audio data of programs, and the advertisement reception task defines an execution content which includes an execution schedule of a reception process for advertisement data including at least one of video data, still image data, and audio data of advertisements. The connection step connects the information processing apparatus to a server. The task execution step executes the program reception task and the advertisement reception task, based on the execution schedules which are set in the program reception task and the advertisement reception task, respectively, thereby executing reception of the program data and reception of the advertisement data from the server independently from each other.

An information processing system according to the present invention is an information processing system constituted of a server and at least one information processing apparatus. The server includes transmission means capable of transmitting program data and advertisement data independently from each other. The program data includes video and audio data of a program, and the advertisement data includes at least one of video data, still image data, and audio data of an advertisement. The information processing apparatus includes task setting means, connection means, and task execution means. The task setting means sets a program reception task and an advertisement reception task. The program reception task defines an execution content which includes an execution schedule of a reception process for the program data and the advertisement reception task defines an execution content which includes an execution schedule of a reception process for the advertisement data. The connection means connects the information processing apparatus to a server. The task execution means executes the program reception task and the advertisement reception task, based on the execution schedules which are set in the program reception task and the advertisement reception task, respectively, thereby executing reception of the program data and reception of the advertisement data from the server independently from each other.

According to the present invention, the amount of data required per reception process is reduced, and thereby a processing load related to reception can be dispersed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a game apparatus 10 in an opened state;

FIG. 2A is a left side view of the game apparatus 10 in a closed state;

FIG. 2B is a front view of the game apparatus 10 in a closed state;

FIG. 2C is a right side view of the game apparatus 10 in a closed state;

FIG. 2D is a rear view of the game apparatus 10 in a closed state;

FIG. 3 is a block diagram showing an internal configuration of the game apparatus 10;

FIG. 4 is a schematic diagram illustrating an outline of a network configuration according to an embodiment of the present invention;

FIG. 5 is a diagram illustrating an example of a screen of a viewing application which is assumed in the embodiment;

FIG. 6 is a diagram illustrating an example of a screen of a viewing application which is assumed in the embodiment;

FIG. 7 is a diagram illustrating an example of a screen of a viewing application which is assumed in the embodiment;

FIG. 8 is a diagram illustrating an example of a screen of a viewing application which is assumed in the embodiment;

FIG. 9 is a diagram illustrating main data stored in a storage area included in a first microcomputer 37;

FIG. 10 is a diagram illustrating main data stored in a RAM 362;

FIG. 11 is a diagram illustrating main programs and data stored in a main memory;

FIG. 12 is a diagram illustrating an example of a data structure of task data 507;

FIG. 13 is a diagram illustrating an example of a data structure of viewing application data 509;

FIG. 14 is a diagram illustrating a data structure of a program package 601;

FIG. 15 is a diagram illustrating an example of a data structure of a banner advertisement package 603;

FIG. 16 is a diagram illustrating an example of a data structure of a CM advertisement package 604;

FIG. 17 is a diagram illustrating an example of a data structure of a setting package 605;

FIG. 18 is a diagram illustrating a data structure of program viewing data 607, CM viewing data 608, and banner viewing data 609;

FIG. 19 is a flowchart illustrating a microcomputer process executed by the first microcomputer 37;

FIG. 20 is a flowchart illustrating a search process executed by a second microcomputer 361;

FIG. 21 is a flowchart illustrating in detail an “unnoticed communication” process;

FIG. 22 is a flowchart illustrating in detail a viewing application process;

FIG. 23 is a flowchart illustrating in detail a first startup setting process shown in step S102 in FIG. 22;

FIG. 24 is a flowchart illustrating in detail a task scheduling process shown in step S104 in FIG. 22;

FIG. 25 is a flowchart illustrating in detail a main process shown in step S105 in FIG. 22;

FIG. 26 is a flowchart illustrating in detail a program playback process shown in step S167 in FIG. 25;

FIG. 27 is a flowchart illustrating in detail an advertisement listing process shown in step S169 in FIG. 25; and

FIG. 28 is a flowchart illustrating in detail a banner advertisement detail display process shown in step S227 in FIG. 27.

### DESCRIPTION OF THE PREFERRED EMBODIMENTS

Hereinafter, embodiments of the present invention will be described with reference to the drawings. It is noted that the present invention is not limited by the embodiments.

(Structure of Game Apparatus)

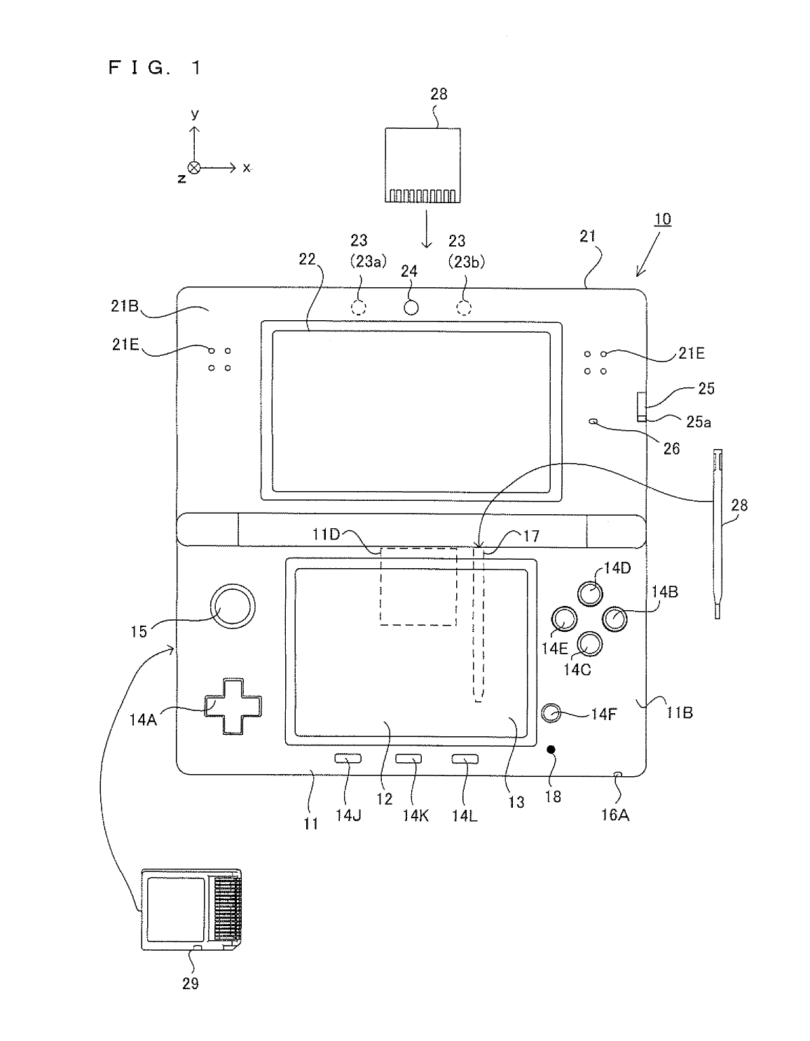

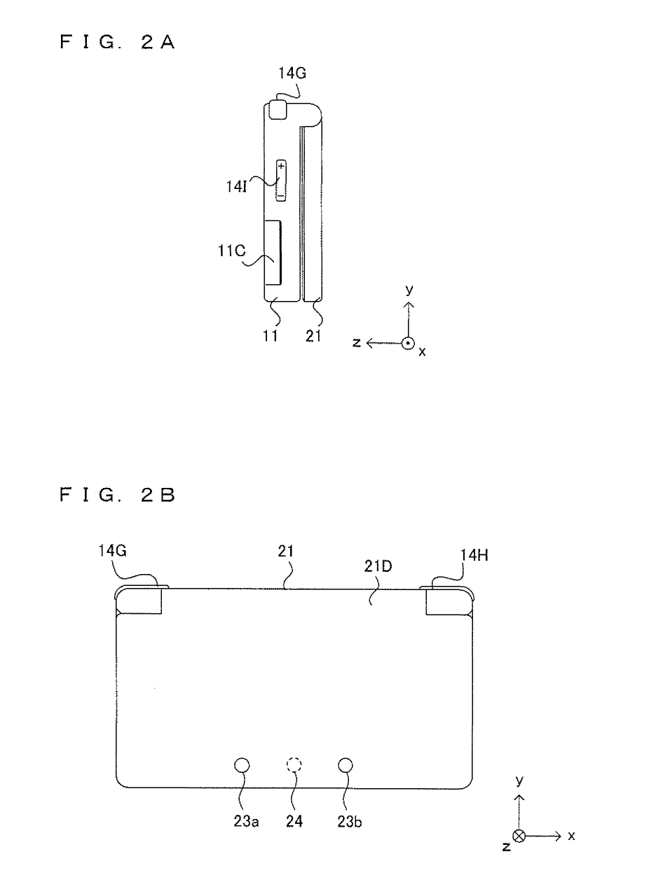

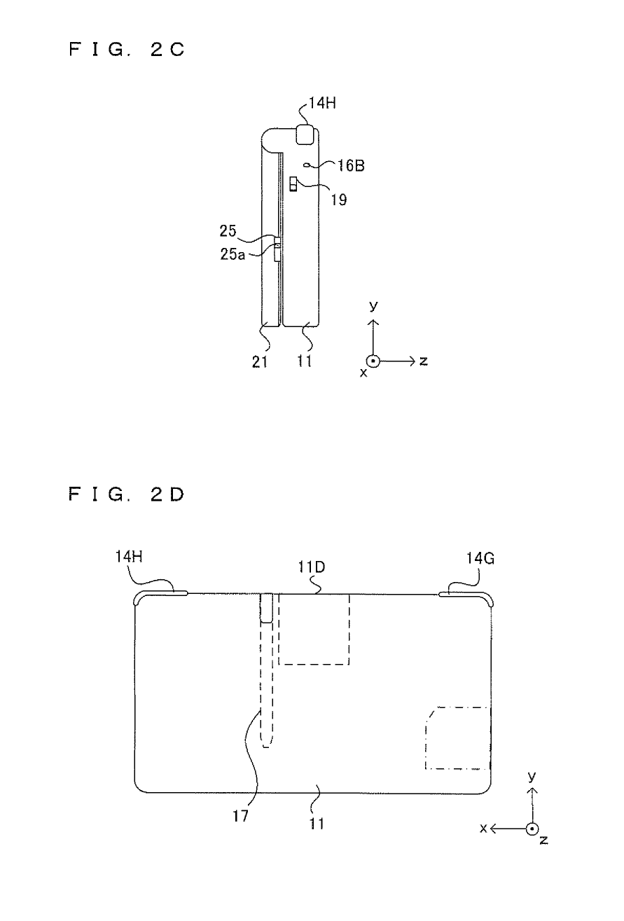

Hereinafter, a game apparatus according to one embodiment of the present invention will be described. A game apparatus 10 is a hand-held game apparatus. The game apparatus 10 includes a lower housing 11 and an upper housing 21 as shown in FIG. 1, and FIG. 2A to FIG. 2D. The lower housing 11 and the upper housing 21 are connected to each other so as to be openable and closable (foldable).

(Description of Lower Housing)

As shown in FIG. 1, and FIG. 2A to FIG. 2D, in the lower housing 11, a lower LCD (Liquid Crystal Display) 12, a touch panel 13, operation buttons 14A to 14L, an analog stick 15, an LED 16A and an LED 16B, an insertion opening 17, and a microphone hole 18 are provided.

The touch panel 13 is mounted on the screen of the lower LCD 12. The insertion opening 17 (indicated by dashed line in FIG. 1 and FIG. 2D) for storing a touch pen 28 is provided on the upper side surface of the lower housing 11.

A cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11.

The analog stick 15 is a device for indicating a direction.

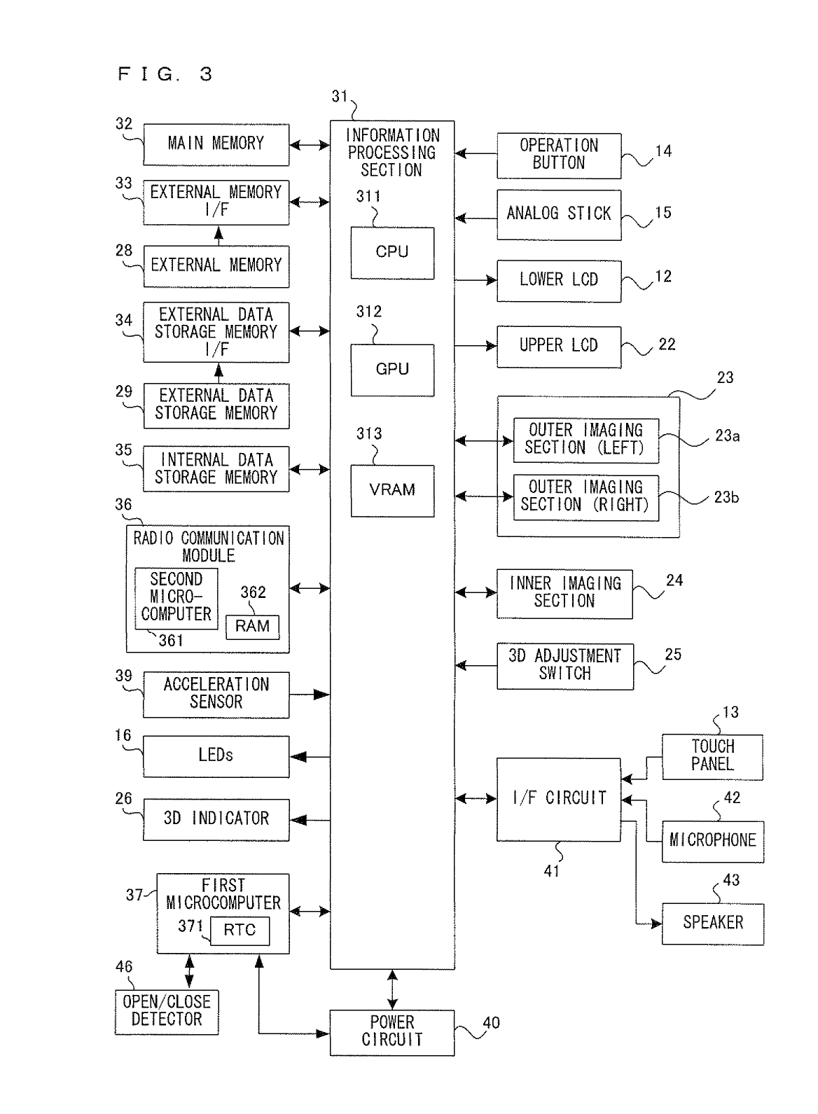

The microphone hole 18 is provided on the inner side surface of the lower housing 11. Under the microphone hole 18, a microphone 42 (see FIG. 3) is provided as a sound input device described below.

As shown in FIG. 2B and FIG. 2D, an L button 14G and an R button 14H are provided on the upper side surface of the lower housing 11 Further, as shown in FIG. 2A, a sound volume button 14I is provided on the left side surface of the lower housing 11. The sound volume button 14I is used for adjusting a sound volume of a speaker 43 (see FIG. 3) of the game apparatus 10.

As shown in FIG. 2A, a cover section 11C is provided on the left side surface of the lower housing 11 so as to be openable and closable. Inside the cover section 11C, a connector is provided for electrically connecting between the game apparatus 10 and an external data storage memory 45.

As shown in FIG. 2D, an insertion opening 11D through which an external memory 44 is inserted is provided on the upper side surface of the lower housing 11.

Further, as shown in FIG. 1 and FIG. 2C, a first LED 16A for notifying a user of an ON/OFF state of a power supply of the game apparatus 10 is provided on the lower side surface of the lower housing 11, and a second LED 16B for notifying a user of an establishment state of a wireless communication of the game apparatus 10 is provided on the right side surface of the lower housing 11. The game apparatus 10 can make wireless communication with other devices. A wireless switch 19 for enabling/disabling the function of the wireless communication is provided on the right side surface of the lower housing 11 (see FIG. 2C).

(Description of Upper Housing)

As shown in FIG. 1 to FIG. 2, in the upper housing 21, an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26 are provided.

The upper LCD 22 is a display device capable of displaying a stereoscopically visible image. Specifically, the upper LCD 22 is a display device capable of displaying an image which is stereoscopically visible with naked eyes. The upper LCD 22 allows the user to view a left-eye image with her/his left eye, and a right-eye image with her/his right eye by utilizing a parallax barrier, so that an image (a stereoscopically visible image) exerting a stereoscopic effect for the user can be displayed. Further, the upper LCD 22 may disable the parallax barrier. When the parallax barrier is disabled, an image can be displayed in a planar manner. Thus, the upper LCD 22 is a display device capable of switching between a stereoscopic display mode for displaying a stereoscopically visible image and a planar display mode (for displaying a planar visible image) for displaying an image in a planar manner. The switching of the display mode is performed by, for example, the 3D adjustment switch 25 described later.

Two imaging sections (23a and 23b) provided on the outer side surface 21D of the upper housing 21 are generically referred to as the outer imaging section 23. The outer imaging section (left) 23a and the outer imaging section (right) 23b can be used as a stereo camera depending on a program executed by the game apparatus 10.

The inner imaging section 24 is positioned on the inner side surface 21B of the upper housing 21, and acts as an imaging section which has an imaging direction which is the same direction as the inward normal direction of the inner side surface.

The 3D adjustment switch 25 is a slide switch, and is used for switching a display mode of the upper LCD 22 as described above. Further, the 3D adjustment switch 25 is used for adjusting the stereoscopic effect of a stereoscopically visible image (stereoscopic image) which is displayed on the upper LCD 22. A slider 25a of the 3D adjustment switch 25 is slidable to any position in a predetermined direction (the height direction), and a display mode of the upper LCD 22 is determined in accordance with the position of the slider 25a. In addition, a manner in which the stereoscopic image is visible is adjusted in accordance with the position of the slider 25a.

The 3D indicator 26 is an LED that indicates whether or not the upper LCD 22 is in the stereoscopic display mode.

In addition, a speaker hole 21E is provided on the inner side surface of the upper housing 21. A sound is outputted through the speaker hole 21E from a speaker 43 described below.

(Internal Configuration of Game Apparatus 10)

Next, an internal electrical configuration of the game apparatus 10 will be described with reference to FIG. 3. As shown in FIG. 3, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a first microcomputer 37, an acceleration sensor 39, a power circuit 40, an interface circuit (I/F circuit) 41, an open/close detector 46, and the like.

The information processing section 31 is information processing means which includes a CPU (Central Processing Unit) 311 for executing a predetermined program, a GPU (Graphics Processing Unit) 312 for performing image processing, VRAM (Video RAM) 313, and the like. The CPU 311 executes a program stored in a memory (for example, the external memory 44 connected to the external memory I/F 33 or the internal data storage memory 35) included in the game apparatus 10, thereby executing processing corresponding to the program. The program executed by the CPU 311 may be acquired from another device through communication with the other device. The GPU 312 generates an image in accordance with an instruction from the CPU 311 of the information processing section 31, and renders the image in the VRAM 313. The image rendered in the VRAM 313 is outputted to the upper LCD 22 and/or the lower LCD 12, and the image is displayed on the upper LCD 22 and/or the lower LCD 12.

The external memory I/F 33 is an interface for detachably connecting to an external memory 28. The external data storage memory I/F 34 is an interface for detachably connecting to an external data storage memory 29.

The main memory 32 is a volatile storage apparatus used as a work area and a buffer area for (the CPU 311 of) the information processing section 31.

The external memory 28 is a nonvolatile storage apparatus for storing, for example, a program executed by the information processing section 31. The external memory 28 is implemented as, for example, a read-only semiconductor memory.

The external data storage memory 29 is implemented as a non-volatile readable and writable memory (for example, a NAND flash memory), and is used for storing given data.

The internal data storage memory 35 is implemented as a non-volatile readable and writable memory (for example, a NAND flash memory), and is used for storing predetermined data. For example, data and/or programs downloaded through the wireless communication module 36 by wireless communication is stored in the internal data storage memory 35.

The wireless communication module 36 has a function of performing wireless communication with another communication apparatus or the like. In the present embodiment, the wireless communication module 36 realizes two types of communication modes, “infrastructure communication” and “ad hoc communication” which are described below. The “infrastructure communication” is a function of connecting to a wireless LAN by using a method based on, for example, IEEE 802.11b/g/n standard. The “ad hoc communication” is a function of performing wireless communication with the same type of game apparatus by a predetermined communication method (for example, communication based on a unique protocol, or infrared communication). Although described in detail below, a process utilizing a communication function called “unnoticed communication”, which uses the “infrastructure communication”, is mainly performed in the present embodiment.

The wireless communication module 36 includes a second microcomputer 361, a RAM 362, and the like. In the RAM 362, programs for controlling the communication functions such as the “infrastructure communication” and the “ad hoc communication” are arbitrarily stored. The second microcomputer 361 controls the above-described “unnoticed communication” and the like, based on the programs stored in the RAM 362.

The acceleration sensor 39 detects magnitudes of accelerations (linear accelerations) in the directions of the straight lines along the three axial (xyz axial) directions, respectively. The information processing section 31 can receive data (acceleration data) indicating accelerations detected by the acceleration sensor 39, and detect an orientation and a motion of the game apparatus 10.

The first microcomputer 37 performs processes such as a process concerning power management of the game apparatus 1, a process concerning time, a process of detecting opening or closing of the housing. In addition, the microcomputer 37 receives a notification concerning these processes from the CPU 311, and also provides a notification to the CPU 311. The microcomputer 37 has a real time clock (RTC) 371. The RTC 371 counts a time and outputs the time to the CPU 311 via the microcomputer 37. For example, the CPU 311 is capable of calculating a current time (date) and the like on the basis of the time counted by the RTC 371.

The first microcomputer 37 is connected to the open/close detector 46 and the power circuit 40. The open/close detector 46 detects opening or closing of the housing, and notifies the microcomputer 37 (further the CPU 311) of the detection result. The power circuit 40 controls power supplied from a power supply (typically, a battery accommodated in the lower housing 11) of the game apparatus 10 and supplies the power to each component of the game apparatus 10. In addition, the power circuit 40 receives a notification of shift to a sleep mode or cancellation of the sleep mode, from the microcomputer 37 (from the CPU 311 via the microcomputer 37). Then, the power circuit 40 performs control for appropriately supplying power, on the basis of the notification.

Now, a power control mode of the game apparatus 10 according to the present embodiment will be described. After the power supply such as a battery is mounted to the game apparatus 10 so as to allow power to be supplied to each component, the game apparatus 10 basically operates in any one of two power control modes that are a “normal power mode” and a “power saving mode”. The “normal power mode” is a state where power is supplied to all the components. For example, when the user operates the game apparatus 10 and plays a predetermined game, or when the user operates various applications, the power control mode is the “normal power mode”. The “power saving mode” is a state where power supply to only some of the components is continued and power supply to the other components is stopped. In the present embodiment, the “power saving mode” includes a “sleep mode”. The “sleep mode” is a state where power is supplied to only the first microcomputer 37 and the wireless communication module 36 and power supply to the other components such as the CPU 311 and the LCDs is stopped (it should be noted that the CPU 311 is capable of receiving an instruction for cancelling the “sleep mode”). Further, in the “sleep mode”, the microcomputer 37 and (the second microcomputer 361 of) the wireless communication module 36 repeatedly perform processes called “microcomputer process” and “during-sleep BG communication process”, respectively, in predetermined cycles. These processes will be described in detail below.

In the present embodiment, in addition to the method of shifting to the sleep mode or cancelling the sleep mode on the basis of the detection result of the open/close detector 46 as described above, it is possible to change the power control mode between the “normal power mode” and the “sleep mode” in accordance with an operation of the power button 14F. Moreover, in addition to an operation of the power button 14F, it is possible to automatically cancel the “sleep mode” or shift to the “sleep mode” by a process described below. For example, after the user finishes playing a certain game, if the user presses the power button 14F (it seems to the user that this operation is an operation to turn off the power), the game apparatus 10 shifts to the “sleep mode”. In this state, the user can close and carry the game apparatus 10. Then, if the user opens the game apparatus 10 and presses the power button 14F again, the “sleep mode” is cancelled and the game apparatus 10 shifts to the “normal power mode”. Alternatively, the game apparatus 10 may shift to the “sleep mode” when a predetermined time period elapses from the last operation.

Further, by pressing the power button 14F for a predetermined time period or longer, it is possible to shift to a “complete stop mode” in which power supply to all the components including the first microcomputer 37 and the wireless communication module 36 is stopped (namely, the power is completely turned off). In this case, if the power button 14F is pressed for the predetermined time period or longer, the game apparatus 10 starts up to shift to the “normal power mode”.

Here, in view of whether or not the user is using the game apparatus 10, the power control mode can be rephrased as follows. That is, the game apparatus 10 has two states, namely, a “used state” and an “unused state”. The “used state” is a state where the normal power mode continues since the user opens the housing of the game apparatus 10 and directly uses the game apparatus 10. For example, a state where the user plays a game or the like by operating the operation button 14 or the like, corresponds to this state. On the other hand, the “unused state” is a state where the user does not independently and directly use the game apparatus 10. The “unused state” also includes a state where the power control mode is the “sleep mode” since the housing is closed, as well as a state where, in performing the “unnoticed communication” described below, the “sleep mode” is temporarily cancelled (while the housing is closed), a process concerning the “unnoticed communication” is performed, and the game apparatus 10 returns to the “sleep mode” after performing the “unnoticed communication”. For example, a state where the user closes the housing of the game apparatus 10 and the game apparatus 10 is put in a bag when the user goes out, is the “unused state”. Further, as described above, a state where the “sleep mode” is temporarily cancelled while the game apparatus 10 is put in the bag and the user goes out, and a state where the game apparatus 10 shifts to the “sleep mode” again after the “unnoticed communication” is performed (in this state, the user does not use the game apparatus 10), are also the “unused state”. Further, in addition to opening or closing of the housing, the trigger for changing the state of the game apparatus 10 between the “used state” and the “unused state” also includes an operation of the power button 14F. In other words, the user has been playing a game (used state), and, then, by the user pressing the power button 14F of the game apparatus 10 after finishing the game play, the state of the game apparatus 10 is changed from the “used state” to the “unused state”. Further, for example, when the user has not performed any operation for a constant time period, the state of the game apparatus 10 may be changed from the “used state” to the “unused state”.

In the following description, for simplification of explanation, the power control mode will be described using an example where only the “normal power mode” and the “sleep mode” are used.

The touch panel 13, the microphone 42, and the speaker 43 are connected to the I/F circuit 41. The I/F circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data on the basis of a signal outputted from the touch panel 13, and outputs the touch position data to the information processing section 31. The information processing section 31 obtains the touch position data, to recognize a position on which an input is made on the touch panel 13.

The operation button 14 includes the operation buttons 14A to 14L described above, and operation data indicating an input state of each of the operation buttons 14A to 14L (whether or not each button has been pressed) is outputted from the operation button 14 to the information processing section 31.

The lower LCD 12 and the upper LCD 22 are connected to the information processing section 31. Specifically, the information processing section 31 is connected to an LCD controller (not shown) of the upper LCD 22, and causes the LCD controller to set the parallax barrier to ON or OFF. When the parallax barrier is set to ON in the upper LCD 22, a right-eye image and a left-eye image that are stored in the VRAM 313 of the information processing section 31 are outputted to the upper LCD 22. More specifically, the LCD controller alternately repeats reading of pixel data of the right-eye image for one line in the vertical direction, and reading of pixel data of the left-eye image for one line in the vertical direction, thereby reading, from the VRAM 313, the right-eye image and the left-eye image. Thus, an image to be displayed is divided into the right-eye images and the left-eye images each of which is a rectangle-shaped image having one line of pixels aligned in the vertical direction, and an image, in which the rectangle-shaped left-eye image which is obtained through the division, and the rectangle-shaped right-eye image which is obtained through the division are alternately aligned, is displayed on the screen of the upper LCD 22. A user views the images through the parallax barrier in the upper LCD 22, so that the right-eye image is viewed by the user's right eye, and the left-eye image is viewed by the user's left eye. Thus, the stereoscopically visible image is displayed on the screen of the upper LCD 22.

The outer imaging section 23 and the inner imaging section 24 each take an image in accordance with an instruction from the information processing section 31, and output data of the taken image to the information processing section 31.

The 3D adjustment switch 25 transmits an electrical signal corresponding to the position of the slider 25a, to the information processing section 31.

The information processing section 31 controls whether or not the 3D indicator 26 is to be lit up. For example, the information processing section 31 lights up the 3D indicator 26 when the upper LCD 22 is in the stereoscopic display mode.

Next, the outline of processing executed in the present embodiment will be described. The processing of the present embodiment includes: receiving data of videos and the like distributed from a predetermined server, and reproducing the data by the game apparatus 10. Specifically, in the present embodiment, videos and the like to be received are “programs” and “advertisements” created by creators at TV stations or the like. In the present embodiment, data of the “programs” and data of the “advertisements” are individually received and transmitted. That is, on the server side, the data of the “program” and the data of the “advertisement” are prepared as different files, and are configured to be individually transmittable (in response to a request of the game apparatus 10). On the other hand, in the game apparatus 10, a process of receiving the “programs” and a processing receiving the “advertisements” are executed as different processes. Further, in the present embodiment, a communication process called “unnoticed communication” is executed mainly as a background process, and thereby the data of the “programs” and the data of the “advertisements” are automatically received in the background without a user's active operation to receive the same.

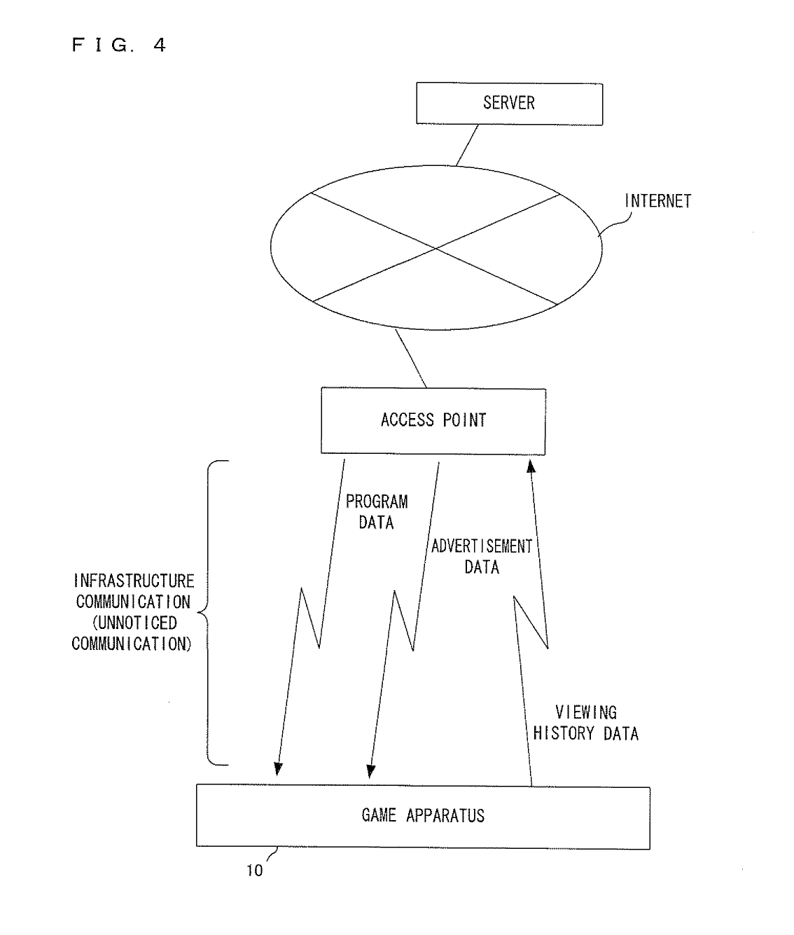

Next, the outline of the “unnoticed communication” of the present embodiment will be described. Firstly, a specific example of the “unnoticed communication” will be described. Here, a network configuration as shown in FIG. 4 is assumed. The game apparatus 10 establishes a connection to an access point (referred to as “AP”, hereinafter) in a wireless LAN by using a function of “infrastructure communication”. Then, the game apparatus 10 is connected to the Internet via the AP, and performs communication with a predetermined server. In the present embodiment, the game apparatus 10 receives data of “programs” and “advertisements” from the server. In addition, the game apparatus 10 transmits, to the server, data indicating a viewing history of the user.

As described above, the “unnoticed communication” is basically executed as a background process, regardless of whether the game apparatus 10 is in the “sleep mode” or in the “normal power mode”. A typical example of the “unnoticed communication” is performed at a user's home. In this case, the above-described AP is an access point installed in the user's home. The user sets the game apparatus 10 in the “sleep mode” (the state where the game apparatus 10 is folded) and goes to bed. The game apparatus 10 automatically executes the “unnoticed communication” to receive data of “programs” and “advertisements” while the user is sleeping. When the user wakes up next morning and sets the game apparatus 10 in the “normal power mode”, new “programs” and “advertisements” have been distributed, so that the user can view the “programs” and “advertisements” on the game apparatus 10. Alternatively, there is a case where the “unnoticed communication” is performed in a place other than home. In this case, the above-described AP is installed in a predetermined shop (such as a fast food shop). When the user goes out with the game apparatus 10 being set in the “sleep mode” and drops in the shop, the game apparatus 10 automatically establishes a connection to the AP in the shop, and executes the “unnoticed communication”. That is, while the user stays in the shop (the game apparatus may be either in the “sleep mode” or in the “normal power mode”), the game apparatus 10 receives the data of “programs” and “advertisements”. When the user comes home or when the user is in a train or the like on his/her way home, the user can view the newly received “programs” and “advertisements” on the game apparatus 10. Thus, in the present embodiment, the game apparatus 10 can receive data of “programs” and “advertisements” by using the “unnoticed communication” before the user knows it. In the present embodiment, since the data of “programs” and the data of “advertisements” are treated (received) as separated data, the following process is realized.

The following will describe the concept of a “task” which is a unit for managing each process in the “unnoticed communication”. In the present embodiment, a “task” defines the content of a process for transmitting or receiving predetermined data to/from a predetermined server. One “task” corresponds to one transmission process or reception process. Therefore, in the present embodiment, two types of “tasks”, a “transmission task” and a “reception task”, are managed. That is, in one “task”, either of “transmission” or “reception” is defined. In the present embodiment, execution schedules or the like of the “transmission task” and the “reception task” are defined and registered in the system of the game apparatus 10, thereby to manage execution thereof in the background. Specifically, a “reception task” for receiving “programs” (referred to as “program reception task”, hereinafter) and a “reception task” for receiving “advertisements” (referred to as “advertisement reception task”, hereinafter) are defined as different tasks (whose execution schedules or the like are different from each other), and registered. In the present embodiment, two stations, a TV station A and a TV station B, are assumed as the sources of “programs” and the like. Each station provides three “programs”. That is, in the present embodiment, a total of six “programs” are supplied from the two TV stations. Examples of three programs from the TV station A include: a “news” updated every several hours, a “drama” updated every day, and an “information/variety program” updated every week. On the other hand, as for the “program reception task”, one task corresponds to one program. Accordingly, in the present embodiment, a total of six “program reception tasks” are registered. On the other hand, as for the “advertisement reception task”, in the present embodiment, two “reception tasks” are registered. In the present embodiment, the “advertisements” are sorted into “CM advertisements” and “banner advertisements”. The “CM advertisements” are represented as video data. The “banner advertisements” are represented as still image data. Therefore, as for the “advertisement reception task”, two tasks, i.e., a “reception task” of “CM advertisements” (referred to as a “CM advertisement reception task”, hereinafter) and a “reception task” of “banner advertisements” (referred to as a “banner advertisement reception task, hereinafter), are registered. Further, in the present embodiment, data of a plurality of CM advertisements are included in a file of CM advertisements received by execution of the “CM advertisement reception task”. Likewise, data of a plurality of banner advertisements are included in a file of banner advertisements received by execution of the “banner advertisement reception task”.

Further, in the present embodiment, in addition to the above-described “reception tasks”, a “setting file reception task” and a “viewing history transmission task” are also registered and executed. The “setting file reception task” is a “task” for receiving a setting file. The setting file is a file for setting an execution schedule or the like of the “task”. Although details will be described below, the game apparatus 10 is capable of changing the execution schedule (execution priority, execution time, and the like) of each “task” with reference to the setting file. The “viewing history transmission task” is a “transmission task” for transmitting, to a predetermined server, history data representing programs and advertisements that the user has viewed.

Further, in the present embodiment, a “task” called a “maker program reception task” is also registered. This is a “reception task” for receiving “programs” (referred to as “maker programs”, hereinafter) provided by a maker of the game apparatus 10. The “maker programs” are moving images mainly showing demonstration videos or various kinds of “information” from the maker.

In the present embodiment, up to 99 “tasks” can be registered (there are “tasks” utilized in processes (e.g., a game process) other than the processes of the present embodiment). If a “task” is registered exceeding this limitation, the oldest task in the registration order is overwritten.

The main content defined in each “task” includes, firstly, information relating to an execution schedule of the task. The execution schedule includes information such as “execution priority”, “next-execution time”, “execution interval”, “number of uses”, and the like. These pieces of information define when the “transmission task” or the “reception task” is to be executed, how frequently the task is to be executed, and the like. In addition, information (a data storage place or the like) about data to be transmitted/received next is also included. Moreover, information (a URL or the like) of a server to be a communication partner is also included. These pieces of information are managed as task data 507 described later, and therefore, will be described in detail when the task data 507 is described.

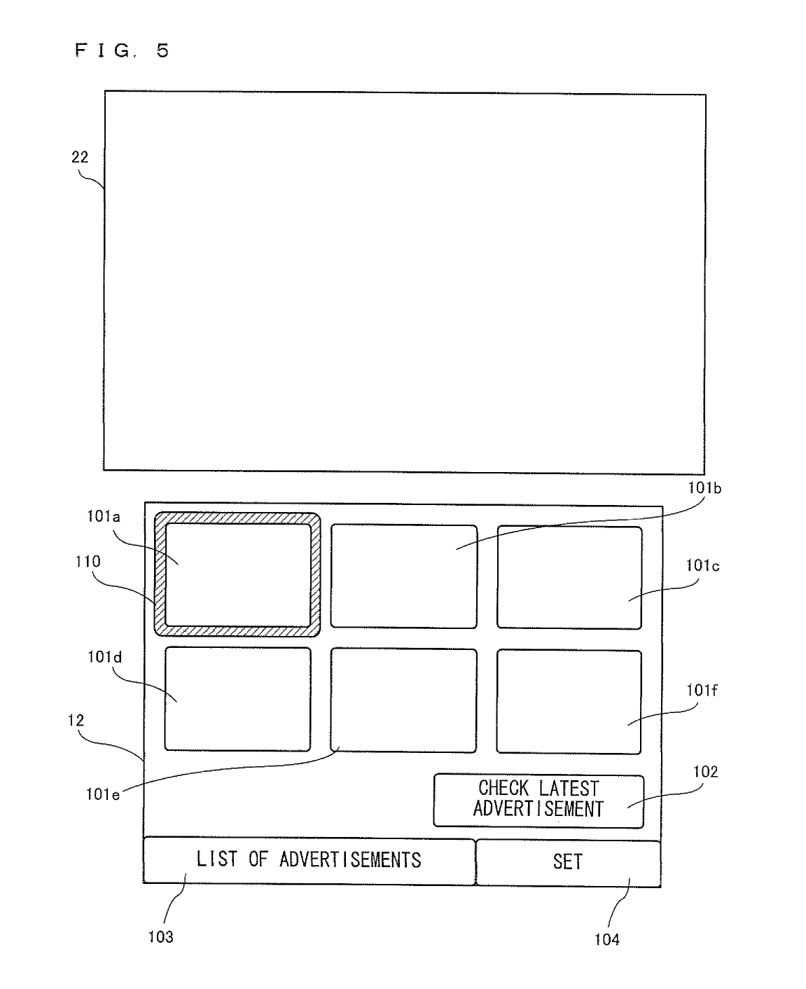

The following will describe an outline of a viewing process for viewing “programs” and “advertisements” received by the above-described “unnoticed communication”. FIGS. 5 to 8 show examples of screens of a viewing application executed by the game apparatus 10. The viewing application is started up based on a user's operation to a home menu (not shown) of the game apparatus 10, for example. The screen shown in FIG. 5 is a menu screen of the viewing application. On the menu screen shown in the lower LCD 12, six icons 101 (program icons 101a to 1010 each showing a program are displayed. Further, an immediate update button 102, an advertisement list button 103, and a setting button 104 are also displayed on the lower LCD 12. Further, a cursor 110 for indicating a currently selected program or button is also displayed. The user performs, on the lower LCD 12, a touch operation or the like to a program icon 101 on which the cursor 110 is placed, and thus the user can play each program or perform a process corresponding to each button. On the menu screen shown in the upper LCD 22, explanation of the program icon 101 or the like selected on the lower LCD 12 (such as introduction of the program content) is appropriately displayed.

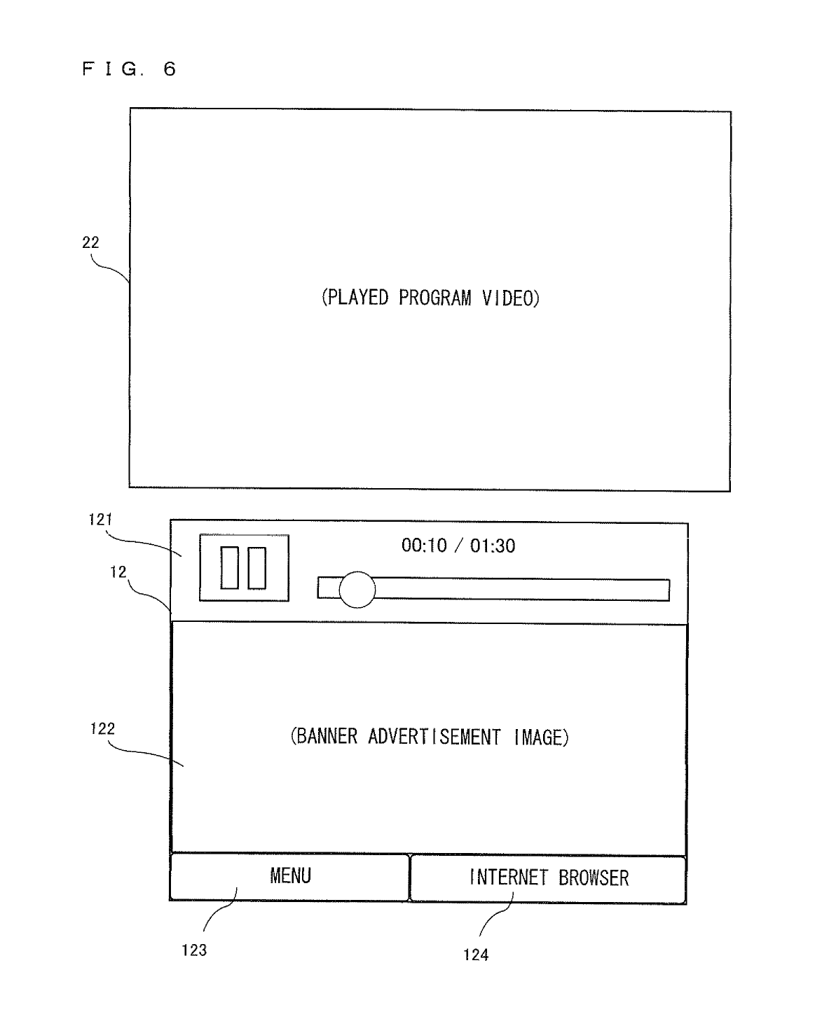

In FIG. 5, when the user performs, on the lower LCD 12, an instruction to play a desired program, the menu screen is changed to a program playback screen as shown in FIG. 6. In FIG. 6, on the upper LCD 22, a video of a program or a CM advertisement is displayed. On the other hand, on the lower LCD 12, a playback control panel 121 is displayed on an upper part thereof, a banner advertisement image 122 is displayed beneath the playback control panel 121, and a menu button 123 and a browser start button 124 are displayed beneath the banner advertisement image 122. The video played on the upper LCD 22 can be controlled by operating the playback control panel 121 (a seek bar or a play/pause button).

In the present embodiment, as described above, data of “programs” and data of “advertisements” are separately received. On the other hand, when a program is played on the program playback screen, CM advertisements are appropriately played during the program. Specifically, the following setting process is executed. That is, when playback of a program is instructed, the already-received file of CM advertisements is referred to and, as a rule, some CM advertisements are selected at random and played during playback of the program (including before and after starting the program). Thereby, when playback of the program is started, the CM advertisements are selected at random regardless of the content of the program, and the selected CM advertisements are appropriately played during the program. Thus, playback such as playback of a general television program is realized.

In the present embodiment, when the viewing application is started up, if there are unviewed programs, a control for starting playback of any one of the unviewed programs (automatic playback of an unviewed program) is performed without displaying the menu screen. That is, there are cases where not the menu screen but the program playback screen is displayed when the viewing application is started up. Further, in the present embodiment, the programs are supplied from two the TV stations as described above. In this case, when performing automatic playback of unviewed programs, a control for providing the programs of the both TV stations with equal opportunities of playback may be performed in order to avoid a situation that the played programs are from only either of the TV stations.

The following will describe a display mode of the banner advertisement image 122 on the lower LCD 12. The banner advertisement image 122 is an image included in the banner advertisement file received by the above-described “banner advertisement reception task”. As described above, data of “programs” and data of “advertisements” are separately received. Therefore, when a program playback instruction is made, banner advertisements to be displayed during this playback are selected at random, and the selected banner advertisements are displayed on the lower LCD 12 while being appropriately switched during playback of the program on the upper LCD 22. A period of time during which each banner advertisement image is displayed is included in data of the corresponding banner advertisement. However, when the moving picture of the CM advertisement is being played on the upper LCD 22, a banner advertisement related to a commercial product or the like introduced in the CM advertisement is displayed. That is, a banner advertisement image related to the CM advertisement is displayed. For example, when a CM advertisement of a cosmetic of a company A is played, a banner advertisement image showing the cosmetic is displayed on the lower LCD 12 while the CM advertisement is being played. Hereinafter, such a banner advertisement linked to a CM advertisement is referred to as an associated banner advertisement.

Further, in FIG. 6, the browser start button 124 is a button which allows the user to start up a WEB browser and view a site (a site of an advertiser or a shopping site) linked to an banner advertisement image which is displayed then. When the browser start button 124 is pressed, playback of the program is temporarily stopped. Then, the viewing application is changed to a background process (for example, enters a stand-by state), and a process relating to the WEB browser is started as a foreground process. Thereafter, when the process relating to the WEB browser is ended, the viewing application is changed to the foreground process, and playback of the program is resumed from the position where the playback has temporarily been stopped.

In FIG. 6, the menu button 123 is a button for ending the program playback screen to return to the menu screen shown in FIG. 5.

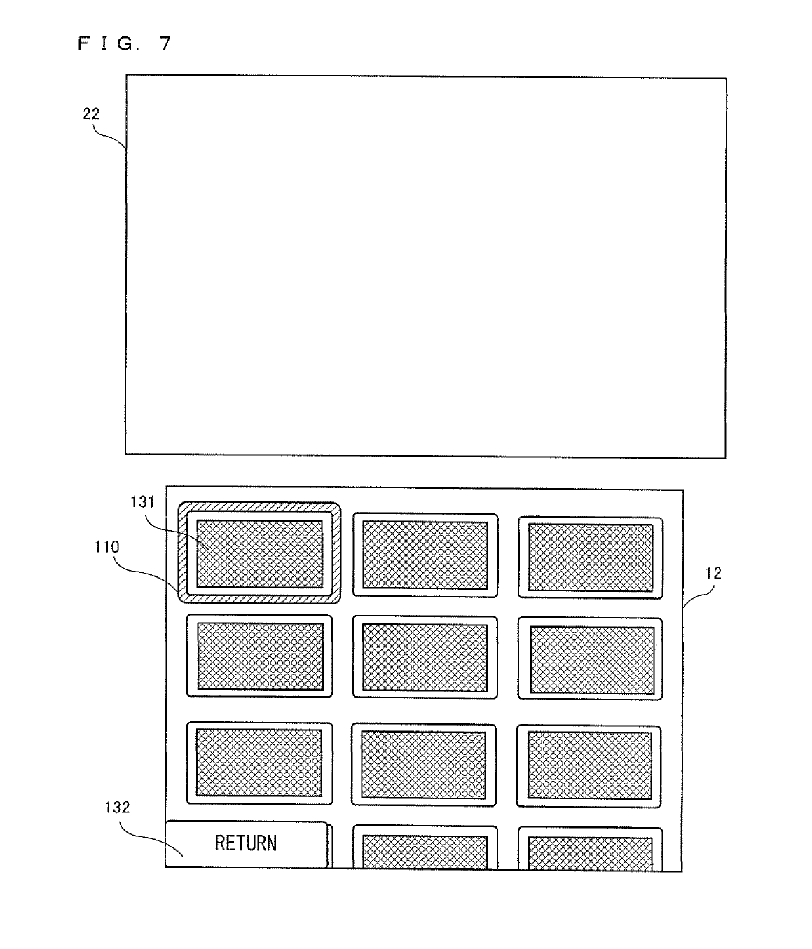

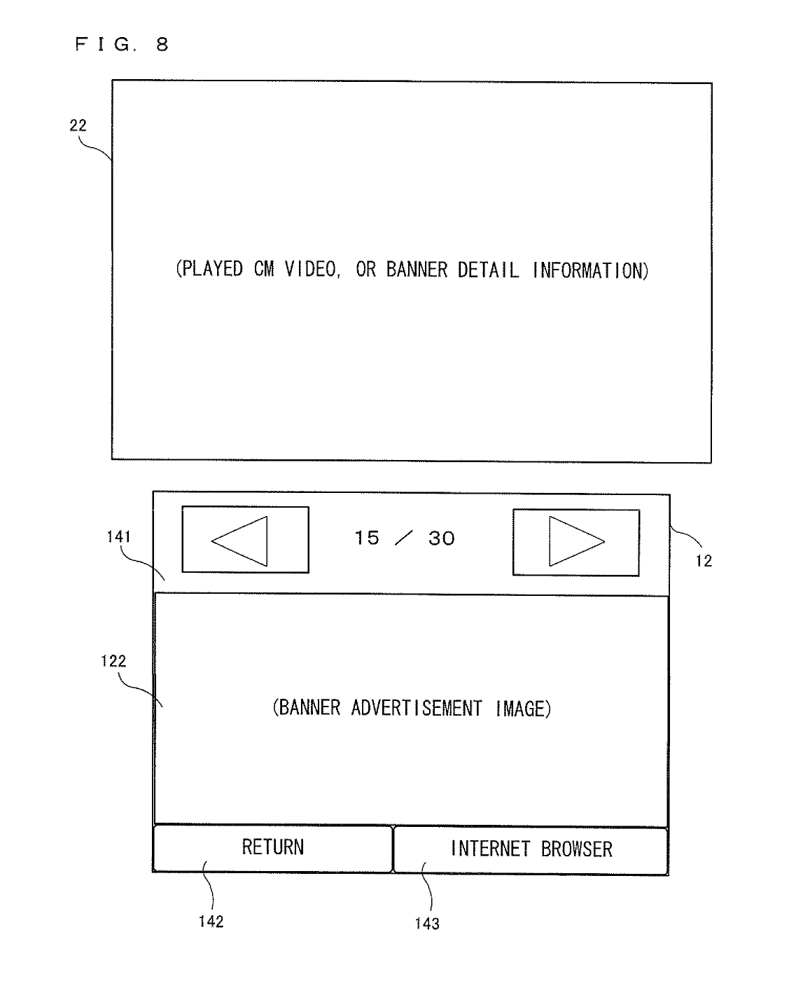

Referring back to FIG. 5, the following will describe an outline of a process performed when the user presses the advertisement list button 103 on the lower LCD 12. In this case, an advertisement list screen as shown in FIG. 7 is displayed. This screen allows the user to view the respective banner advertisements included in the file of banner advertisements received by the “banner advertisement reception task”. As described above, in the present embodiment, data of “programs” and data of “advertisements” are separately received, which allows the user to view only the advertisements. On the advertisement list screen shown in the lower LCD 12, a list of thumbnail images 131 of banner advertisements is displayed. Further, the cursor 110 is also displayed. When the user places the cursor 110 on his/her desired banner advertisement image by operating the analog stick 15 or the like, information related to the banner advertisement (such as contact for inquiries about the advertisement, or bibliographic information such as publication period) is displayed on the upper screen. When the user places the cursor 110 on the thumbnail image of his/her desired banner advertisement and performs an operation to determine the banner advertisement, a banner advertisement detail screen as shown in FIG. 8 is displayed. In FIG. 8, a viewing control panel 141 for controlling viewing and playback of banner advertisements, and a selected banner advertisement image 122 are displayed on the lower LCD 12. When there is a CM advertisement linked to the selected banner advertisement image, a video of the CM advertisement is played on the upper LCD 22. When there is no linked CM advertisement, information related to the banner advertisement is displayed.

Further, a return button 142 and a browser start button 143 are also displayed on the lower LCD 12. The return button 142 is a button for returning to the advertisement list screen. The browser start button 143 is a button for starting a WEB browser to view a site linked to a banner advertisement image displayed then.

Referring back to FIG. 5, the following will describe a process to be performed when the user presses the setting button 104 on the lower LCD 12. At this time, a screen (not shown) for performing setting related to the viewing application is displayed. This screen allows the user to perform various kinds of setting operations related to the operation of the viewing application. For example, the user is allowed to set, for example, whether or not automatic reception of videos and advertisements should be performed (i.e., whether or not the above-described “unnoticed communication” should be executed). When the user touches the immediate update button 102 on the lower LCD 12, determination as to whether or not a latest program or the like exists is executed. When a latest program or the like exists, a process of receiving data of the program is executed. This reception process causes immediate execution of the above-described “program reception task” and “advertisement reception task” (that is, the reception process is performed as a background process).

As described above, in the present embodiment, data of “programs” and data of “advertisements” are separately received. When playing a program, advertisements to be played together with the program are determined each time. Therefore, the load on the network can be dispersed. Further, a process of viewing only the advertisements is possible.

The following will describe in detail the “unnoticed communication” process and the viewing application process, which are performed in the game apparatus 10. Prior to the description, components that perform the processes in the present embodiment will be described. In the present embodiment, the first microcomputer 37, the second microcomputer 361, and the CPU 311 independently perform the processes described below, and these processes are performed in a cooperative manner and in parallel with each other. First, main data used in the respective processes of the present application will be described.

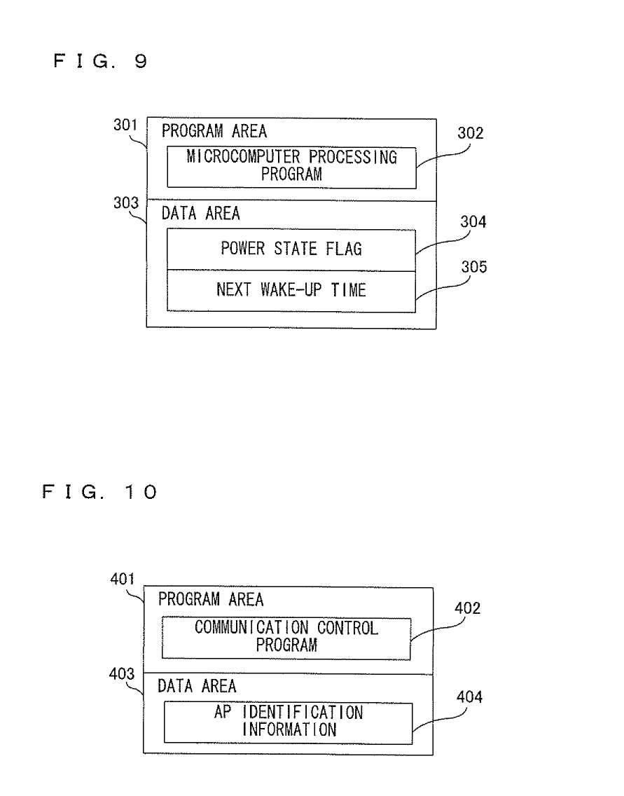

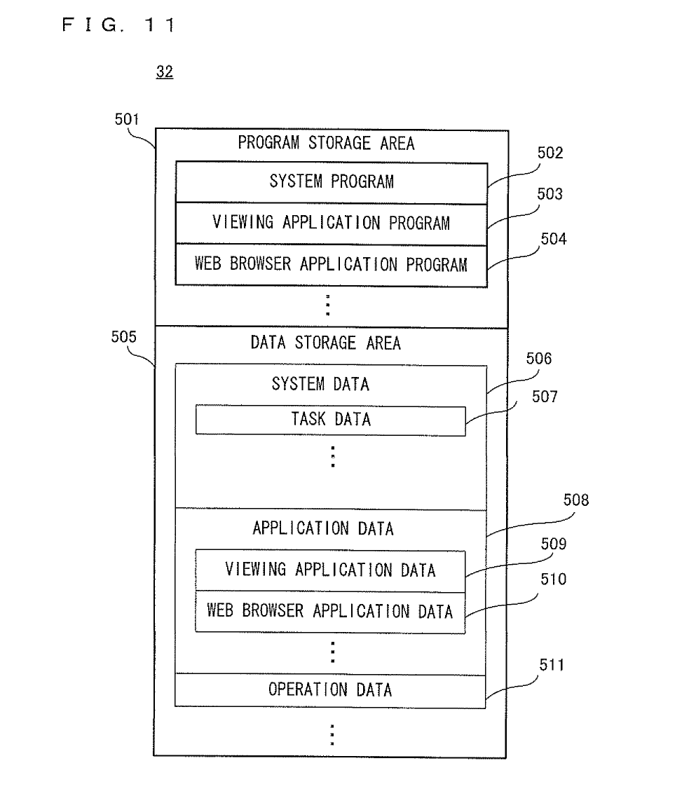

FIG. 9 is a diagram illustrating main data stored in a storage area (not shown) included in the first microcomputer 37. In the first microcomputer 37, a program area 301 and a data area 303 are present. In the program area 301, a microcomputer process program 302 for the first microcomputer 37 to perform processes is stored. In the data area 303, a power supply state flag 304 and a next wake-up time 305 are stored. The power supply state flag 304 indicates whether or not the game apparatus 10 is in the “sleep mode”. When the power supply state flag 304 is set to ON, it indicates that the game apparatus 10 is in the “normal power mode”. When the power supply state flag 304 is set to OFF, it indicates that the game apparatus 10 is in the “sleep mode”. The next wake-up time 305 is data indicating a time to cancel the “sleep mode”.

FIG. 10 is a diagram illustrating main data stored in the RAM 362 included in the wireless communication module 36. In the RAM 362, a program area 401 and a data area 403 are present. In the program area 401, a communication control program 402 is stored. This program is for controlling a process relating to the above-described infrastructure communication. In addition, a process of searching for APs is also achieved by this program. In the data area 403, AP identification information 404 including information (SSIDs and the like) relating to APs is stored.

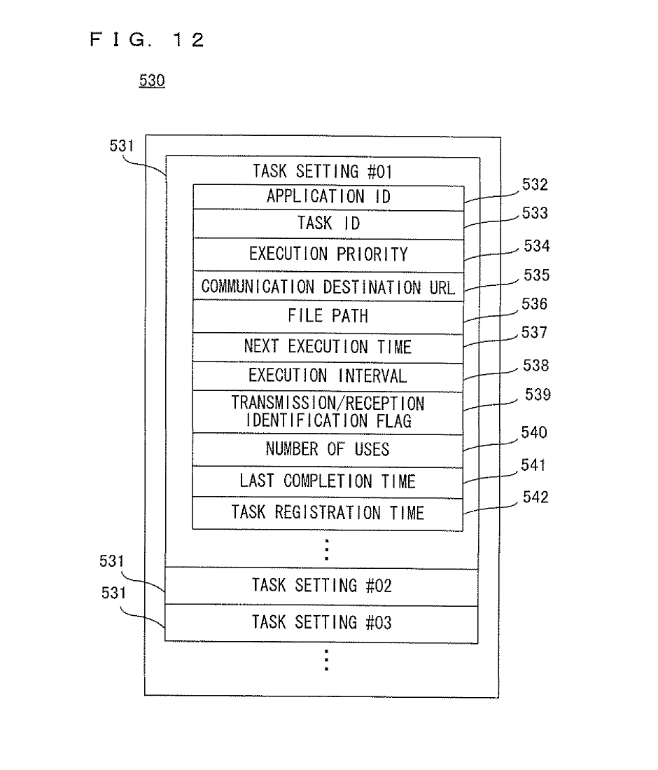

FIG. 11 is a diagram illustrating a memory map of the main memory 32 of the game apparatus 10. In FIG. 11, the main memory 32 includes a program storage area 501 and a data storage area 505. Data in the program storage area 501 and the data storage area 505 are stored in the internal data storage memory 35 or the external data storage memory 29, and are transmitted to and stored in the main memory 32 according to need when a process of the present embodiment is executed. In the present embodiment, among the programs and data shown in FIG. 11, a viewing application program 503 and viewing application data 509 are basically stored in the external data storage memory 29. Other programs and data are basically stored in the internal data storage memory 35.

In the program storage area 501, a system program 502, a viewing application program 503, and a WEB browser application program 504 are stored. The system program includes various programs relating to the system of the game apparatus 10, such as a program for executing the “unnoticed communication” process, and a program for displaying/controlling a home menu. The viewing application program 503 is a program for realizing the above-described viewing application. The WEB browser application program 504 is a program far executing a WEB browser application called from the viewing application or the like.

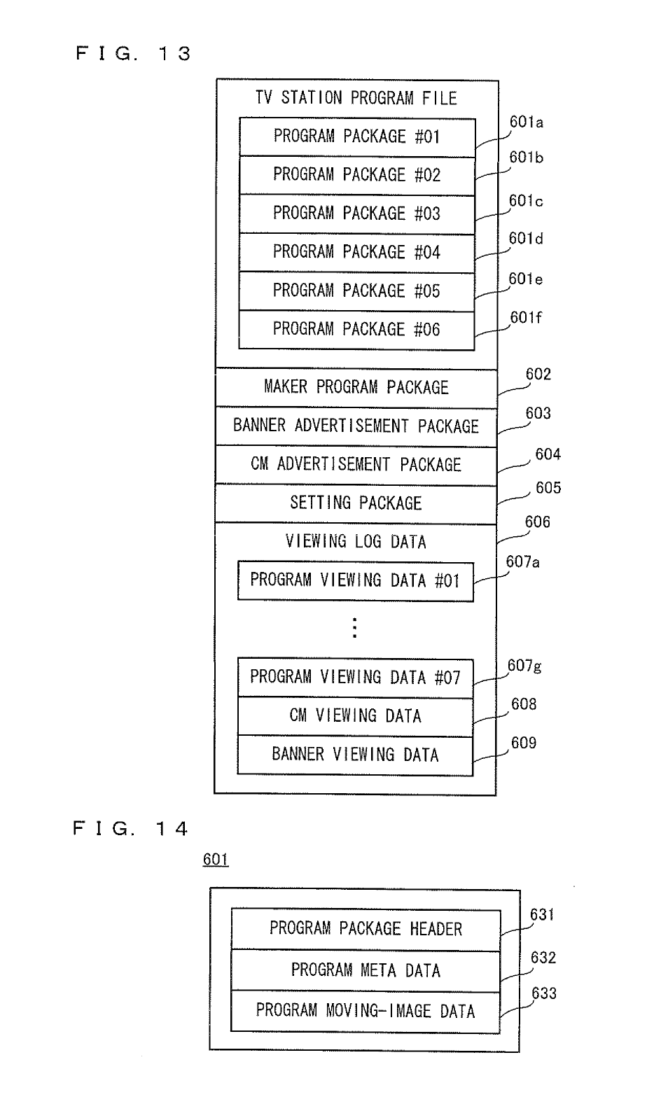

In the data storage area 505, system data 506, application data 508, and operation data 511 are stored. The system data 506 includes task data 507 and the like. The task data 507 is data for defining the content of the above-described “task”. FIG. 12 is a diagram illustrating an example of a data structure of the task data 507. In the task data 507, a plurality of task settings 531 are stored. Each task setting 531 is constituted of an application ID 532, a task ID 533, an execution priority 534, a communication destination URL 535, a file path 536, a next execution time 537, an execution interval 538, a transmission/reception identification flag 539, a number of uses 540, a last completion time 541, a task registration time 542, and the like.

The application ID 532 is an ID indicating an application or a game (in the present embodiment, the viewing application) related to the “task”. The task ID 533 is an ID for identifying the task.

The execution priority 534 is data indicating the execution priority of the “task”. In the present embodiment, five-level execution priority is defined. Specifically, “EXPEDITE”, “HIGH”, “MEDIUM”, “LOW”, and “STOPPED” are defined in descending order of priority. In this data, information indicating any of these priority levels is stored.

The communication destination URL 535 indicates a commutation destination of the “task” (for example, in the present embodiment, a server from which is “programs” and “advertisements” are download).

The file path 536 is data indicating a location, in the game apparatus 10, for storing each of files to be transmitted (uploaded) or received (downloaded) by the “unnoticed communication”. For example, in the case of the “transmission task”, a file stored in a location on the memory, which is indicated by the file path 536, is transmitted to a server indicated by the communication destination URL 535. In the case of the “reception task”, data (in the present embodiment, a file of “programs”, “advertisements”, or “settings”) received from a server indicated by the communication destination URL 535 is stored in a location on the memory, which is indicated by the file path 536.

The next execution time 537 is data indicating a time when the “task” is to be executed next. The execution interval 538 is data indicating the execution interval of the “task”. For example, data indicating every three hours, every four hours, every day, or the like, is stored therein. The execution interval 538 is used for determining the next execution time 537.

The transmission/reception identification flag 539 is a flag indicating whether the “task” is a “transmission task” for transmitting predetermined data, or a “reception task” for receiving predetermined data. For example, when this flag is set to be ON, it indicates that the “task” is the “reception task”, and when the flag is set to be OFF, it indicates that the “task” is the “transmission task”.

The number of uses 540 indicates the number of uses for the “task”. Hereinafter, the number of uses will be described. The number of uses indicates the number of times the “task” can be executed. In the present embodiment, when the “task” is newly generated/registered, a predetermined numerical value is set as an initial value for the number of uses 540. The number of uses 540 is decremented by one every time the “task” is executed. The number of uses 540 is reset to the initial value every time an application or the like corresponding to the “task” is started. In the present embodiment, a control is performed, in which a “task” whose number of uses 540 becomes 0 (in other words, an application or a game corresponding to this “task” has not been executed for a long period) is not executed regardless of the content of the execution priority 534 (the “task” itself remains without being erased). In the present embodiment, the number of uses of the “program reception task” is not reset to the initial value even when the viewing application is started, but it is reset to the initial value every time the corresponding program is viewed. Therefore, if a state where a certain program among the above-described six programs is never viewed continues, the number of uses of the “reception task” of this program is continuously decremented, and finally, becomes 0, which may cause a situation where only the “reception task” of this program is not executed.

The last completion time 541 is data indicating a time when the “task” of the task setting 531 is executed last and completed successfully. The task registration time 542 is data indicating a time when the task setting 531 is generated and registered for the first time.

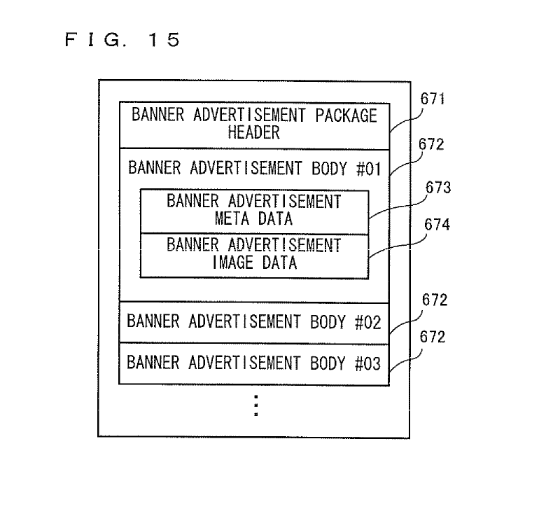

Referring back to FIG. 11, the application data 508 includes data used in various applications and games, such as viewing application data 509, WEB browser application data 510, and the like. The viewing application data 509 is mainly used for the above-described viewing application. FIG. 13 is a diagram illustrating an example of a data structure of the viewing application data 509. The viewing application data 509 is constituted of program packages 601a to 601f (hereinafter, these program packages may be collectively referred to as a program package 601), a maker program package 602, a banner advertisement package 603, a CM advertisement package 604, a setting package 605, a viewing log data 606, and the like. The program package 601 is a file indicating a “program” distributed from the above-described TV station, and one program package 601 corresponds to one program.

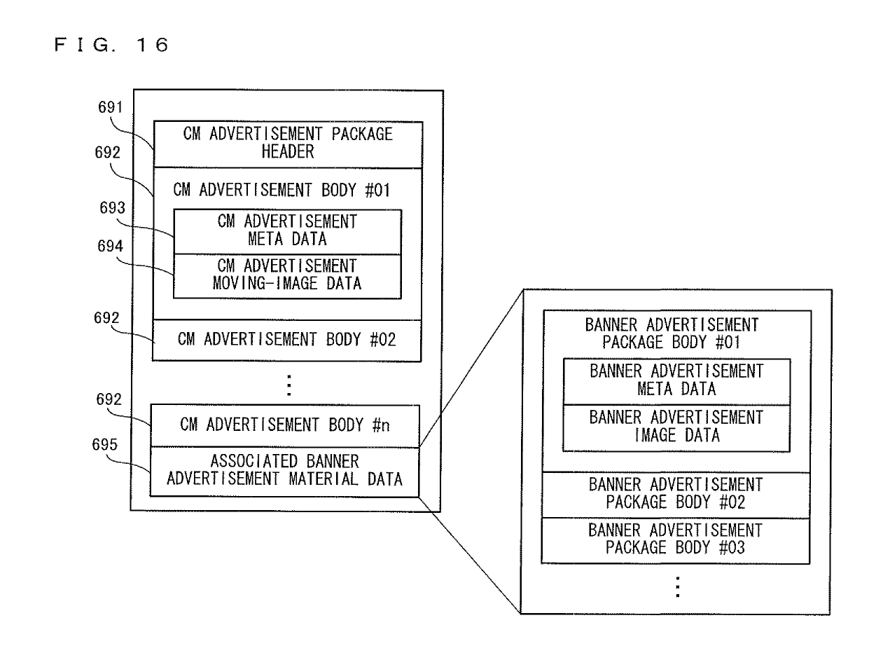

FIG. 14 is a diagram illustrating an example of a data structure of the program package 601. Each program package 601 includes a program package header 631, a program metadata 632, and a program video data 633. The program package header 631 includes information for uniquely identifying the program package (since, in the present embodiment, there are seven “programs” including six programs distributed from the TV stations and a maker program), information indicating the version of the program package, thumbnail image data, and the like.

The program metadata 632 includes bibliographic information of the program, for example, the title of the program, a brief guide of the program, and the like. The program metadata 632 further includes information about an effective playback period of the program. For example, if an effective playback period of a program is defined as 2011 Jun. 1 to 2011 Jun. 30, this program can be played only during this period.

The program video data 633 is video data of this program. For example, it is video data encoded in the H.264 format.

Referring back to FIG. 13, the maker program package 602 is a file indicating a “program” provided by the maker of the game apparatus 10. The content of the program includes, for example, various kinds of “messages” and “demo videos”. Since the data structure of the maker program package 602 is identical to that of the program package 601, repeated description is not necessary.

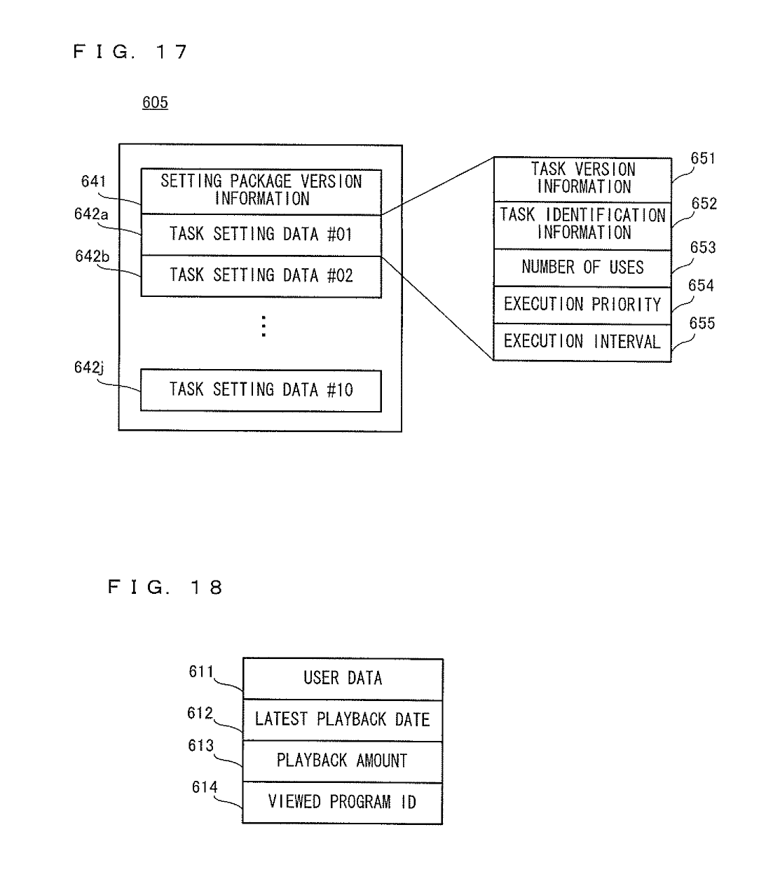

The banner advertisement package 603 is a file including the above-described banner advertisements. FIG. 15 is a diagram illustrating an example of a data structure of the banner advertisement package 603. The banner advertisement package 603 is constituted of a banner advertisement package header 671, and a plurality of banner advertisement bodies 672. Each of the banner advertisement bodies 672 corresponds to one banner advertisement. That is, in the banner advertisement package 603, a plurality of banner advertisements are multiplexed and stored. Each banner advertisement body 672 is constituted of banner advertisement metadata 673, and banner advertisement image data 674.

The banner advertisement package header 671 includes information indicating the version of the banner advertisement package 603, and information indicating the number of banner advertisements (i.e., the number of banner advertisement bodies 672) included in the banner advertisement package 603. The banner advertisement package header 671 further includes banner advertisement index information indicating a position of each banner advertisement body 672 included in the banner advertisement package 603. This information enables searching for each banner advertisement body 672 included in the banner advertisement package 603.

The banner advertisement metadata 673 includes bibliographic information of the banner advertisement, for example, the image size of the banner advertisement, URL information linked to the banner advertisement, and the like. For example, when the browser start button 124 shown in FIG. 6 is pressed, the URL information is used. The banner advertisement metadata 673 further includes information indicating a period of time during which the banner advertisement is displayed (banner playback time). For example, when this information defines that the banner playback time is 5 seconds, a control is performed such that the image of the banner advertisement is displayed for 5 seconds during program playback and then changed to another banner advertisement image.

The banner advertisement image data 674 is image data of a banner advertisement, and it is still image data in the jpeg format, for example.

Referring back to FIG. 13, the CM advertisement package 604 is a file including the above-described CM advertisements. FIG. 16 is a diagram illustrating an example of a data structure of the CM advertisement package 604. The CM advertisement package 604 is constituted of a CM advertisement package header 691, a plurality of CM advertisement bodies 692, and associated banner advertisement material data 695. Each CM advertisement body 692 corresponds to one CM advertisement. That is, like the banner advertisements, a plurality of CM advertisements are multiplexed and stored.

The CM advertisement package header 691 includes information indicating the version of the CM advertisement package 604, and information indicating the number of CM advertisements included in the CM advertisement package 604. The CM advertisement package header 691 further includes information indicating the number of associated banner advertisements included in the CM advertisement package 604. Further, the CM advertisement package header 691 includes CM advertisement index information indicating a position of each CM advertisement body 692 included in the CM advertisement package 604, and associated banner advertisement index information indicating a position of each associated banner advertisement body 672. The CM advertisement index information and the associated banner advertisement index information are used for searching for a CM advertisement or an associated banner advertisement.

The CM advertisement body 692 is constituted of CM advertisement metadata 693, and CM advertisement video data 694. The CM advertisement metadata 693 includes bibliographic information of the CM advertisement, for example, the title of the CM advertisement, the number of associated banner advertisements linked to the CM advertisement, information for specifying the associated banner advertisement, and the like. The CM advertisement video data 694 is video data of the CM advertisement.

The associated banner advertisement material data 695 is data of associated banner advertisements which are linked to any of the CM advertisements, and includes data of a plurality of linked banner advertisements. The data structure of each associated banner advertisement is identical to that of the banner advertisement body 672.

Referring back to FIG. 13, the setting package 605 is a file which defines the contents of “tasks” related to the viewing application, that is, “reception tasks” for receiving the “programs”, “advertisements”, and “settings (setting packages)”, and a “transmission task” for transmitting a viewing log. For example, when the TV station A desires to change the distribution schedule of a program (frequency of reception of this program in the game apparatus 10), information indicating the content of this change is included in the setting package 605 to be distributed. In each game apparatus 10 that receives this setting package 605, the execution schedule of the “reception task” of the corresponding program is changed with reference to the setting package 605. Thus, the distribution schedule of the program can be changed.

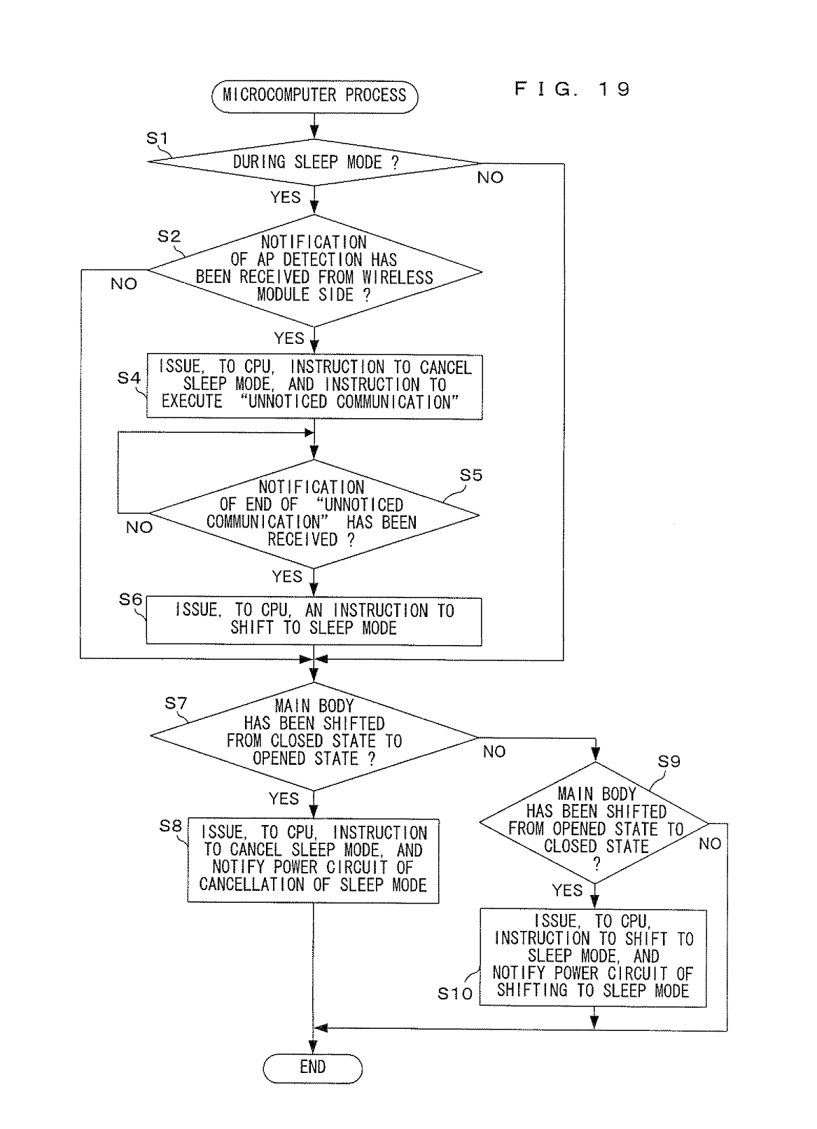

FIG. 17 is a diagram illustrating an example of a data structure of the setting package 605. The setting package 605 is constituted of setting package version information 641, and a plurality of task setting data 642. The setting package version information 641 is information indicating the version of the setting package 605. For example, when the content of the task setting data 642 described below is changed, the content of the setting package version information 641 can be changed each time (for example, count-up of the version number).

The task setting data 642 is information indicating the defined content of each of tasks (ten tasks in the present embodiment) used for the viewing application. Each task setting data 642 includes task version information 651, task identification information 652, a number of uses 653, an execution priority 654, and an execution interval 655. The task version information 651 is information indicating the version of the task setting data 642. The task identification information 652 is information for identifying a “task” corresponding to the task setting data 642. That is, the task setting data 642 is information indicating a “task”, among the ten “tasks”, to which the task setting data 642 corresponds (is applied). The number of uses 653, the execution priority 654, and the execution interval 655 are data to be set as (applied to) the number of uses 540, the execution priority 534, and the execution interval 538 of the above-described task setting 531 (refer to FIG. 12).

Referring back to FIG. 13, the viewing log data 606 is data related to programs and advertisements that the user has viewed. This data is defined as a target to be transmitted by the “transmission task”, and is appropriately transmitted to a predetermined server by the “unnoticed communication”. The viewing log data 606 includes program viewing data 607, CM viewing data 608, and banner viewing data 609. The program viewing data 607 is data indicating a program that the user has viewed, and the program viewing data 607 is prepared for each of the six programs. The CM viewing data 608 is data indicating a CM advertisement that the user has viewed. The banner viewing data 609 is data indicating a banner advertisement that the user has viewed. The data structures of these three pieces of viewing data are identical to each other. FIG. 18 is a diagram illustrating the data structure of each viewing data. Each viewing data includes user data 611, latest playback date 612, playback amount 613, and viewed program ID 614. The user data 611 is information indicating the user of the game apparatus 10. For example, the user data 611 may be user information stored in the body of the game apparatus 10, or information stored by “user information registration” executed at the first startup of the viewing application. The latest playback date 612 is data indicating the latest date when the program, or CM advertisement, or banner advertisement was viewed. The latest playback date 612 is recorded in minutes. The playback amount 613 is information indicating how far a video such as a program or a CM advertisement has been played (where playback is paused/stopped). For example, the video playback time is divided into three periods, “a period from start to less than ⅓”, “a period from ⅓ to ⅔”, and “a period from ⅔ to end”, and the playback amount 613 indicates how far the video has been viewed. The viewed program ID 614 is information for identifying the viewed program, CM advertisement, or banner advertisement.

In addition to the above-described data, the viewing application data 509 includes various kinds of data required for execution of the viewing application. For example, the viewing application data 509 includes setting data related to the operation of the viewing application (which can be set by a setting process when the user presses the setting button 104 displayed on the lower LCD 12 in FIG. 5).

Referring back to FIG. 11, the WEB browser application data 510 includes various kinds of data used for the WEB browser application.

The operation data 511 includes data indicating the input states to the operation button 14, the analog stick 15, the touch panel 13, and the acceleration sensor 39.

The data storage area 505 is used as a temporary storage area for the data received in the “unnoticed communication”, for example.

Hereinafter, the processes executed by the game apparatus 10 will be described in detail with reference to the flowcharts shown in FIGS. 19 to 28. Firstly, the process related to the “unnoticed communication” will be described, and thereafter, the process of the viewing application will be described in detail. The process related to the “unnoticed communication” is constituted of a process executed by the first microcomputer 37, a process executed by the wireless communication module 36 (the second microcomputer 361), and a process executed by the CPU 311. This is because the “unnoticed communication” also relates to the switching control between the “sleep mode” and the “normal power mode”.

(Process Executed by First Microcomputer 37)

Firstly, a process executed by the first microcomputer 37 will be described. FIG. 19 is a flowchart illustrating a microcomputer process executed by the first microcomputer 37. The process shown in FIG. 19 is repeated at predetermined intervals as a background process unless the power of the game apparatus 10 is completely turned off.

Referring to FIG. 19, firstly, in step S1, it is determined whether or not the game apparatus 10 is in the “sleep mode”. Specifically, this determination is performed by referring to the power supply state flag 304. As a result of the determination, when the game apparatus 10 is not in the “sleep mode” (NO in step S1), the process goes to step S7 described later. On the other hand, when the game apparatus 10 is in the “sleep mode” (YES in step S1), it is determined in step S2 whether or not a notification that an AP is detected, which notification is issued from (the second microcomputer 361 of) the wireless communication module 36, has been received (this notification is issued in later-described step S24 in FIG. 16). As a result of the determination, when the notification that an AP is detected has not been issued from the wireless communication module 36 (NO in step S2), the process goes to step S7 described later. On the other hand, when the notification that an AP is detected has been issued from the wireless communication module 36 (YES in step S2), the process goes to step S4. In step S4, an instruction to cancel the “sleep mode” and shift to the “normal power mode” is issued from the first microcomputer 37 to the CPU 311, the power supply state flag 304 is turned on, and a notification that the “sleep mode” is cancelled is issued to the power circuit 40. Further, an instruction to execute the “unnoticed communication” is issued to the CPU 311.

Thereafter, power is temporarily supplied to the CPU 311 such that the CPU 311 becomes operable, and the CPU 311 performs the process related to the “unnoticed communication” as described below. When the process is finished, a notification that the “unnoticed communication” has ended is transmitted from the CPU 311 to the first microcomputer 37.

Next, in step S5, it is determined whether or not the notification that the “unnoticed communication” has ended has been received. When the result of the determination is that the notification has not been received (NO in step S5), the determination in step S5 is repeated (i.e., the first microcomputer 37 waits until the “unnoticed communication” is ended). On the other hand, when the notification has been received (YES in step S5), the process goes to step S6. In step S6, an instruction to shift to the “sleep mode” is issued from the first microcomputer 37 to the CPU 311, the power supply state flag 304 is turned off, and a notification that the “normal power mode” is to be shifted to the “sleep mode” is issued from the first microcomputer 37 to the power circuit 40. It should be noted that the issuance of the instruction to cancel the “sleep mode” and shift to the “normal power mode” in step S4, the determination in step S5, and the issuance of the instruction to shift to the “sleep mode” in step S6 may be performed by the second microcomputer 361 of the wireless communication module 36, not by the first microcomputer 37.

Next, in step S7, it is determined whether or not the game apparatus 10 has been shifted from a closed state (a state in which the housing is closed) to an opened state (a state in which the housing is opened) (i.e., whether or not the game apparatus 10 has been opened). Specifically, the first microcomputer 37 determines whether or not a detection signal indicating that the housing is opened has been received from the open/close detector 46. As a result of the determination, when the game apparatus 10 has been shifted from the closed state to the opened state (YES in step S7), the process goes to step S8. In step S8, an instruction to cancel the “sleep mode” is issued from the first microcomputer 37 to the CPU 311, the power supply state flag 304 is turned on, and a notification that the “sleep mode” is cancelled is issued from the first microcomputer 37 to the power circuit 40. Accordingly, the power circuit 40 starts power supply to the components of the game apparatus 10 as appropriate.

On the other hand, when the result of the determination in step S7 is that the game apparatus 10 has not been shifted from the closed state to the opened state (NO in step S7), the process goes to step S9. In step S9, on the basis of a signal from the open/close detector 46, it is determined whether or not the game apparatus 10 has been shifted from the opened state to the closed state (i.e., whether or not the game apparatus 10 has been closed). As a result of the determination, when the game apparatus 10 has been shifted from the opened state to the closed state (YES in step S9), the process goes to step S10. In step S10, an instruction to shift to the “sleep mode” is issued from the first microcomputer 37 to the CPU 311, the power supply state flag 304 is turned off, and a notification that the “normal power mode” is shifted to the “sleep mode” is issued from the first microcomputer 37 to the power circuit 40. Accordingly, the power circuit 40 stops power supply to the components of the game apparatus 10 as appropriate. On the other hand, when the result of the determination in step S9 is that the game apparatus 10 has not been shifted from the opened state to the closed state (NO in step S9), the process in step S10 is skipped and the microcomputer process is ended.

(Process Executed by Second Microcomputer 361 During “Sleep Mode”)

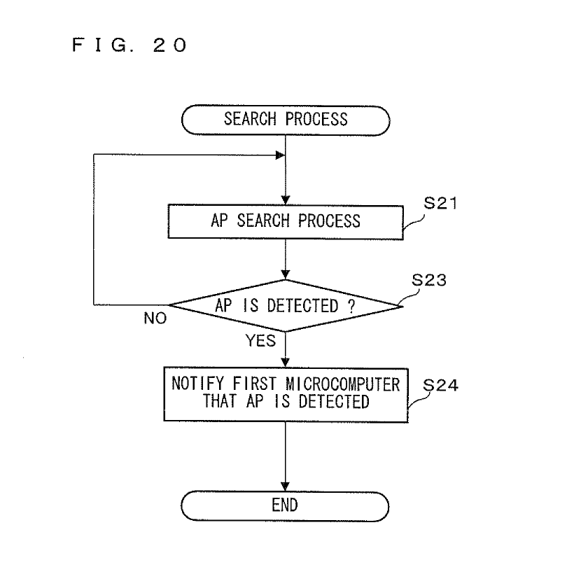

The following will describe a search process executed by the second microcomputer 361 during the “sleep mode”, with reference to FIG. 20. Firstly, search for an AP is performed in step S21. Specifically, search for an AP is performed by so-called passive scanning.

Next, in step S23, it is determined whether or not an AP has been detected in the search process. As a result of the determination, when no AP has been detected (NO in step S23), the process returns to step S21, and the same process is repeated. On the other hand, when an AP has been detected (YES in step S23), a notification that an AP has been detected is issued to the first microcomputer 37 in step S24 (this notification is used for the determination in step S2 in the microcomputer process shown in FIG. 19). As a result, the sleep state of the CPU 311 is temporarily canceled by the signal from the first microcomputer 37, and a process of the “unnoticed communication” described later is executed. When the “unnoticed communication” is ended and the CPU 311 enters the sleep state again, a program of the during-sleep BG communication process is stored in the RAN 362 of the wireless communication module 36, and thus the processes from step S21 are repeated. This is the end of the description of the search process.

(Unnoticed Communication Process)

The following will describe in detail an “unnoticed communication” process. This process is mainly executed by the CPU 311. In the “sleep mode”, the process is executed based on an execution instruction from the first microcomputer 37. In the “normal power mode”, the process is periodically repeated at predetermined intervals as a background process. Accordingly, even when the later-described viewing application or another application is being executed, (reception of programs or the like by) the “unnoticed communication” can be executed in the background in principle.

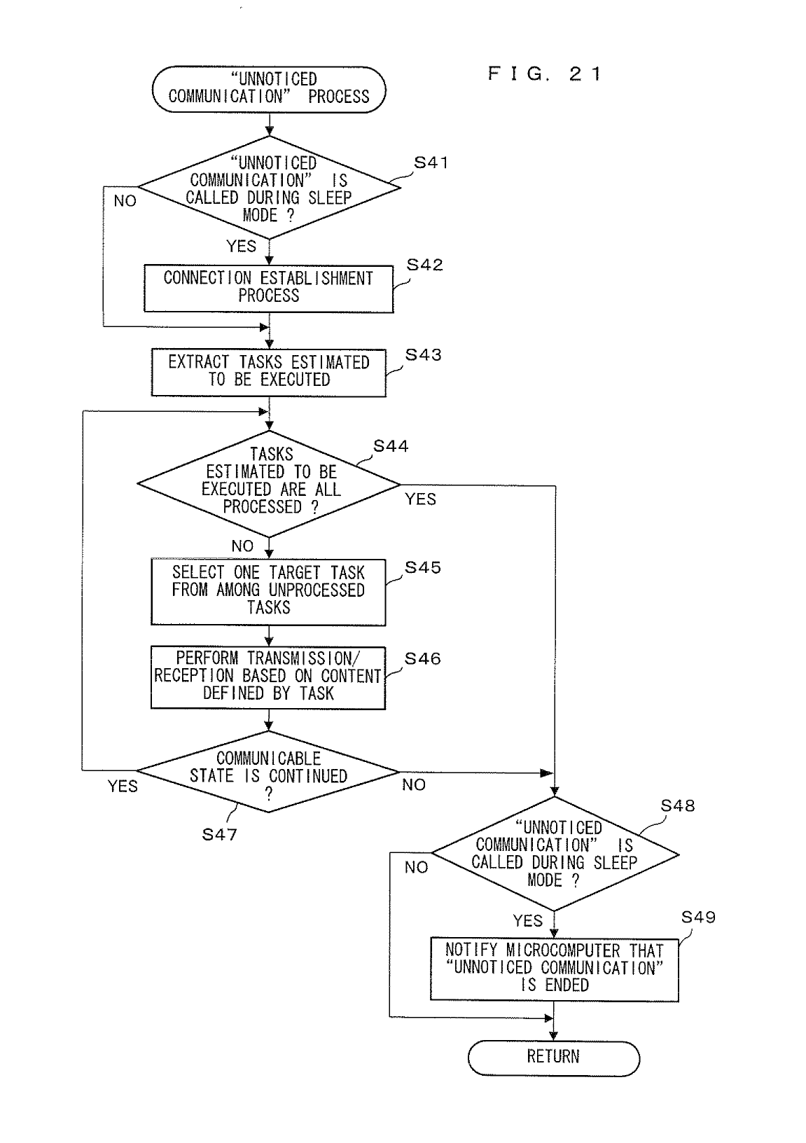

FIG. 21 is a flowchart illustrating in detail the “unnoticed communication” process. Firstly, in step S41, it is determined whether or not the “unnoticed communication” process has been called during the “sleep mode”. That is, it is determined whether or not the “unnoticed communication” process has been executed according to the process of step S4 in the above-described microcomputer process. As a result of the determination, when the process has been called during the “sleep mode” (YES in step S41), a process of establishing a connection to an AP detected during the “sleep mode” is executed in step S42. Then, the process goes to step S43 described later. On the other hand, when the result of the determination in step S41 is that the process has not been called during the “sleep mode” (NO in step S41), the process of step S42 is skipped. In this case, it is understood that the “unnoticed communication” process has been called during the “normal power mode”. If a connection to an AP has not been established at this time, an AP search process and a connection establishment process (both not shown) are appropriately executed, and thereafter, the process goes to step S43.

Next, in step S43, the task data 507 is referred to, and “tasks” which are estimated to be executed at this point in time (including unprocessed tasks whose estimated execution times have already elapsed) are extracted. It should be noted that the extracted “tasks” include “tasks” related to other applications as well as “tasks” related to the viewing application.

Next, in step S44, it is determined whether or not all the extracted tasks, which are estimated to be executed, have been subjected to a process as described below. As a result of the determination, if unprocessed tasks remain (No in step S44), one of the unprocessed tasks is selected as a target task in step S45.

Next, in step S46, the task data 507 corresponding to the target task is referred to, and data transmission/reception or the like is performed between the game apparatus 10 and a predetermined server, based on the defined content of the task data 507. For example, when the target task is a “program reception task”, a process of receiving a program package 601 (one of the above-described six programs), which is related to the task, is performed. When the target task is a “viewing log transmission task”, a process of transmitting the viewing log data 606 to the predetermined server is performed.

Next, in step S47, it is determined whether or not the state where the game apparatus 10 and the AP are communicable is continued (whether or not the game apparatus 10 moves outside the communicable range of the AP). As a result of the determination, when the communicable state is continued (YES in step S47), the process returns to step S44 and the same process is repeated.

On the other hand, when the result of the determination in step S47 is that the game apparatus 10 and the AP are not in the communicable state (NO in step S47) or when the result of the determination in step S44 is that all the tasks estimated to be executed have been processed (YES in step S44), it is determined in step S48 whether or not the “unnoticed communication” process has been called during the “sleep mode”, as in step S41. As a result of the determination, when the process has been called during the “sleep mode” (YES in step S48), a process of returning to the “sleep mode” again is executed. That is, in step S49, a notification that the unnoticed communication has ended is transmitted to the first microcomputer 37. As a result, an instruction to shift to the “sleep mode” is issued from the first microcomputer 37 to the CPU 311.

On the other hand, when the result of the determination in step S48 is that the “unnoticed communication” process has not been called during the “sleep mode” (NO in step S48), it is understood that the process has been called during the “normal power mode”. So, the process of step S49 is skipped, and the “unnoticed communication” process is ended.

(Viewing Application Process)

The following will describe in detail a viewing application process. As described above, execution of this process is started in response to a user's startup instruction on the home menu (for example, user's touching an icon showing the viewing application).

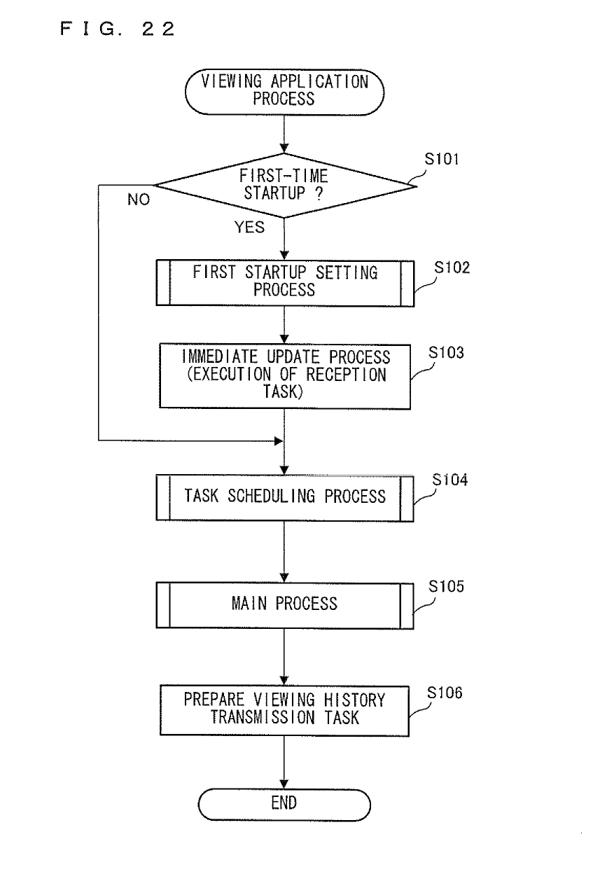

FIG. 22 is a flowchart illustrating in detail the viewing application process. When execution of this process is started, it is determined in step S101 whether or not the viewing application is started up for the first time (first-time startup) from when the application was installed in the game apparatus 10. As a result of the determination, when it is not the first-time startup (NO in step S101), the process goes to step S104 described later. On the other hand, when it is the first-time startup (YES in step S101), a first-startup setting process is executed in step S102. The first-startup setting process is a process for constituting a viewing application execution environment in the game apparatus 10.

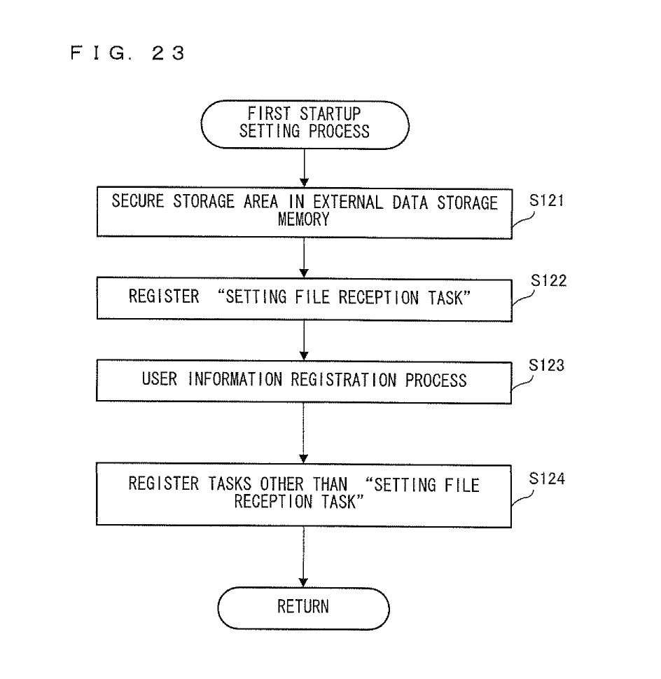

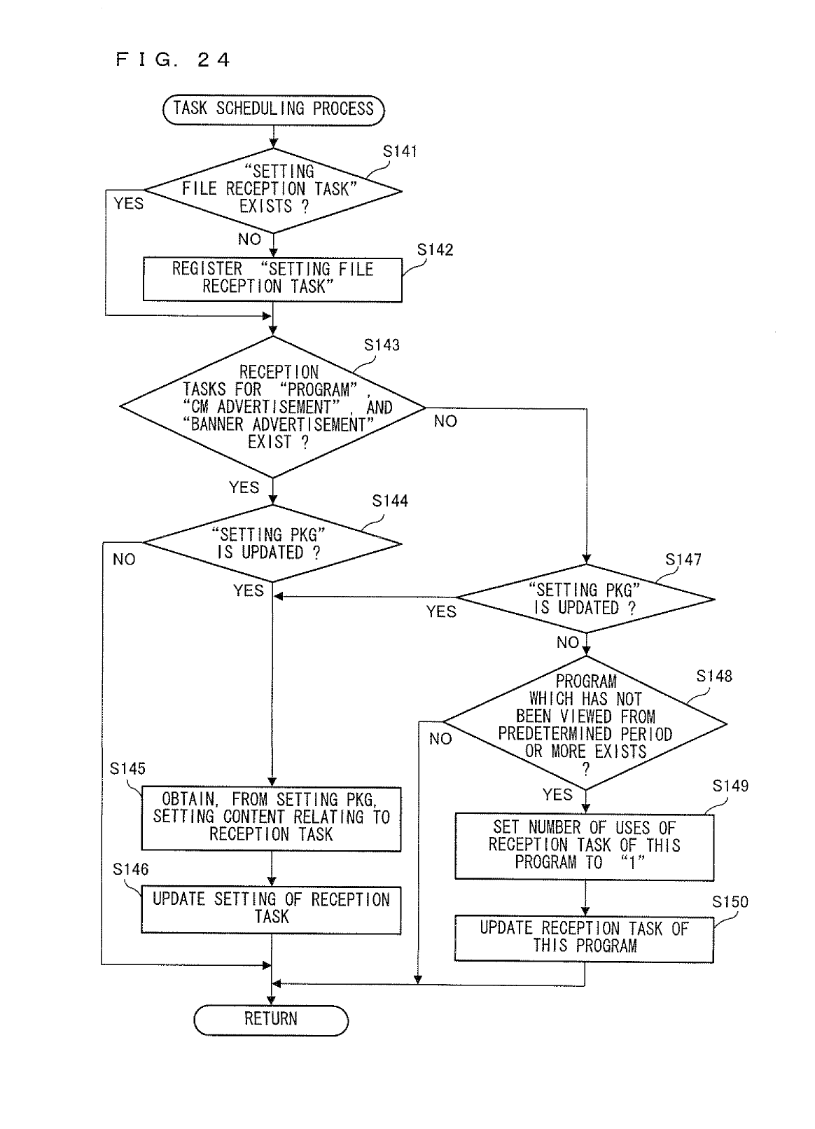

FIG. 23 is a flowchart illustrating in detail the first-startup setting process shown in step S102. With reference to FIG. 23, firstly, in step S121, a process of securing a storage area for storing the data used for the viewing application, i.e., the files of the “programs”, “advertisements”, and “settings”. In the present embodiment, as described above, these data are stored in the external data storage memory 29. Accordingly, in this process, an area for storing the various files as shown in FIG. 13 is secured in the external data storage memory 29.

Next, in step S122, a “setting file reception task”, which is a task for receiving a setting package 605, is created and registered in the system. As for the content (an execution priority and the like) of the “setting file reception task” at this point in time, the content which has previously been defined as initial values is used.

Next, in step S123, a user information registration process is executed. In this process, a various setting input screen is displayed, and information related to the user as a “viewer” is set based on user's inputs to the screen. The user information includes, for example, the birth date and sex of the user. The information thus set (user information which is not shown) is appropriately stored as a part of the viewing application data 509.

After the user information registration process, in step S124, registration of tasks other than the “setting file reception task” is executed. That is, “program reception tasks” (a total of seven tasks for six TV programs and one maker program), a “CM advertisement reception task”, a “banner advertisement reception task”, and a “viewing history transmission task” are created and registered. At this point in time, a latest setting package 605 has not been received yet (in the process of step S122, the “reception task” is merely registered, and “reception” itself is not yet performed). Therefore, the content of each “task” is defined as information such as the execution priority by using the setting package 605 in which initial values are previously set. In the present embodiment, it is assumed that the following content is defined as the initial values. As for the execution priority 534, “LOW” is set for all the reception tasks. As for the execution interval 538, “4 hours” is set for the “program reception task”, “3 hours” for the “advertisement reception task”, and “24 hours” for the “setting file reception task” and the “maker program reception task”. As for the number of uses 540, for example, “50” is set for the “program reception task”, “80” for the “advertisement reception task”, and “100” for the “setting file reception task” and the “maker program reception task”. By executing this process, a total of ten tasks (nine “reception tasks” and one “transmission task”) are registered at this point in time. This is the end of the first-startup setting process.

Referring back to FIG. 22, in step S103, immediate execution of the “reception tasks” registered in the first-startup setting process is performed. That is, at the time of the first-time startup, reception of various “programs” and “advertisements” is attempted. If a communicable AP is present nearby, “programs” and “advertisements” are obtained. If a communicable AP is absent, a message of this effect is appropriately displayed. Hereinafter, the description will be continued on the assumption that “programs” and “advertisements” have been received by executing the process.

Next, in step S104, a task scheduling process is executed. In this process, when the setting package 605 is updated (that is, when the reception frequency or the like of each “program” or “advertisement” is changed), a process of updating each “reception task” with the content of the change is executed.

FIG. 24 is a flowchart illustrating in detail the task scheduling process shown in step S104. Referring to FIG. 24, firstly, in step S141, it is determined whether or not a “setting file reception task” is present (whether or not a “setting file reception task” is registered in the system). The reason is as follows. In the present embodiment, since the maximum number of registerable “tasks” is 99, there is a possibility that a “setting file reception task” which has once been registered might be erased due to this limitation (if a “task” is registered exceeding this limitation, the oldest task is erased). Therefore, it is necessary to confirm presence of a “setting file reception task”. As a result of the determination, when a “setting file reception task” is absent (NO in step S141), registration of a “setting file reception task” is executed in step S142. On the other hand, when a “setting file reception task” is present (YES in step S141), the process of step S142 is skipped.

Next, in step S143, it is determined whether or not all the “program reception tasks” (six tasks), “maker program reception task”, “CM advertisement reception task”, and “banner advertisement reception task” are present. As a result of the determination, when all these tasks are present (YES in step S143), it is determined in step S144 whether or not the setting package 605 has been updated (from when it was received last time). As a result of the determination, when the setting package 605 has been updated (YES in step S144), in step S145, the set content of each “reception task” is obtained by referring to the (updated) setting package 605. In the subsequent step S146, based on the obtained content, the set content of each “reception task” is updated. On the other hand, when the setting package 605 has not been updated (that is, when the content thereof is the same as that at the last reception), the processes of steps S145 and S146 are skipped (the content of each “reception task” is not updated). Then, the task scheduling process is ended.

On the other hand, when the result of determination in step S143 is that at least one “task” is absent among the “program reception tasks” (six tasks), “maker program reception task”, “CM advertisement reception task”, and “banner advertisement reception task” (NO in step S143), it is determined in step S147 whether or not the setting package 605 has been updated. As a result of the determination, when the setting package 605 has been updated (YES in step S147), the process goes to step S145, and the content of the updated setting package 605 is reflected to each “reception task”. As for the absent “task”, a process of registering this “task” is executed.

On the other hand, when the result of determination in step S147 is that the setting package 605 has not been updated (NO in step S147), it is determined in step S148 whether or not there is a program, among the six programs, which has not been viewed for a predetermined period of time or more. For example, it is determined whether or not there is a program which has not been viewed for a week or more. This determination is performed in program units by performing the following process on each program. Firstly, the latest playback date 612 is obtained by referring to the viewing log data 606. Next, the playback start date (the date when the program was distributed) included in the program metadata 632 is obtained. Then, it is determined whether or not the later date between the two obtained dates is a week or more before the current date. As a result of the determination, when the later date is a week or more before the current date, it is determined that the program has not been viewed for a week or more.

When the result of the determination in step S148 is that there is a program which has not been viewed for a predetermined period or more (YES in step S148), “1” is set in the number of uses of the “program reception task” corresponding to the program which has not been viewed. Then, in step S150, the “program reception task” of the program which has not been viewed for a predetermined period or more is updated. This process is performed for the following purpose. If a certain program has not been viewed for a long period but only the reception task of this program is periodically executed, the number of uses becomes “0”, and this program becomes a program whose reception task would not be executed anymore. This program seems to be a program that the user is not interested in (for example, the user is not interested in news programs). As a result, on the menu screen shown in FIG. 5, the same thumbnail of this program is continuously displayed. On the other hand, for example, it is assumed that the TV station renews the content of the program, which has been a news program, to a drama program. In this case, since the reception task of this program is not executed (unless the setting package is updated), it is not possible to let the user be aware of the change of the content of the program. Therefore, in this case, by setting the number of uses to “1”, reception of the program is executed at least once. Thereby, the thumbnail image on the menu screen is changed, which causes the user to be aware of the change, and furthermore, prompts the user to view the program. Of course, the above-described processes in steps S149 and S150 may be performed, not limited to the case where the program is changed, merely when there is a program which has not been viewed for a long period. Also in this case, reception of the program is executed once to prompt the user to view the program by, for example, a change in the thumbnail image on the menu screen.

On the other hand, when the result of the determination in step S148 is that there is no program which has not been viewed for a predetermined period or more (NO in step S148), the task scheduling process is ended.

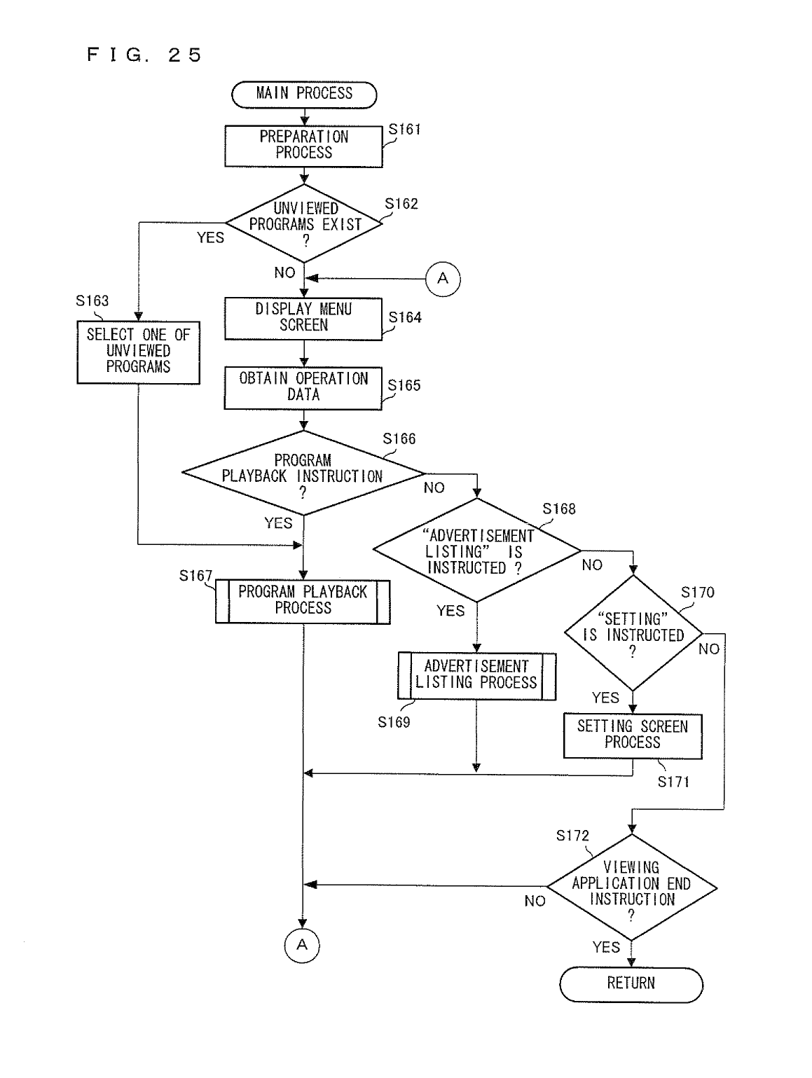

Referring back to FIG. 22, after the task scheduling process in step S104, a main process is executed in step S105. FIG. 25 is a flowchart illustrating the main process in detail. In FIG. 25, firstly, in step S161, a preparation process for preparing a menu screen as shown in FIG. 5 is executed. Specifically, firstly, the program package 601, the banner advertisement package 603, and the CM advertisement package 604 are referred to, and the metadata of programs or advertisements included in these packages are obtained. Further, thumbnail images of the programs and the like are obtained from the metadata, and program icons 101 are generated based on the thumbnail images. Then, a menu screen on which the icons are arranged is generated. At this time, concerning the arrangement order of the program icons 101 on the lower LCD 12, in order to avoid inequality among the TV stations providing the respective programs, the following process is executed. Firstly, a time at which the viewing application was started is obtained. In the system, this time is registered in the form of “hour:minute:second”. Then, it is determined whether or not the value of the lowest digit of “second” is “4” or smaller. As a result of the determination, when the value is “4” or smaller, the program icons 101 are arranged so that the programs provided by the TV station A and the programs provided by the TV station B are alternately arranged with a program provided by the TV station A being located at the beginning (when the menu is displayed for the first time, the cursor 110 is placed on the program icon 101 at the beginning). On the other hand, when the value is not “4” or smaller, the programs of the both stations are alternately arranged with a program provided by the TV station B being located at the beginning. In other words, the TV station providing the program icon 101 to be located at the beginning on the menu screen is varied between the case where the lowest digit of the viewing application startup time is 0 to 4 and the case where it is 5 to 9. Thus, concerning the arrangement order of the program icons 101, inequality is prevented from occurring between the TV stations A and B.

Next, in step S162, it is determined whether or not there is at least one unviewed program, by referring to the viewing log data 606, for example. As a result of the determination, when there are unviewed programs (YES in step S162), in step S163, one program is selected from among the unviewed programs (if there is only one unviewed program, the program is selected). Also in this selection process, in order to avoid inequality between the TV stations, a program of either of the TV stations is selected first in accordance with the value of the lowest digit of the startup time. Alternatively, a program having the oldest distribution date may be preferentially selected. When any of the unviewed programs is thus selected, the process goes to step S167 described later. In step S167, playback of the unviewed program is started (that is, playback of the unviewed program is automatically started).

On the other hand, when the result of determination in step S162 is that there is no unviewed program (NO in step S162), in step S164, the menu screen generated in step S161 is displayed on the lower LCD 12. On the upper LCD 22, a program guide for the program icon 101 on which the cursor 110 is placed is displayed (the program guide is obtained from the metadata of the program).

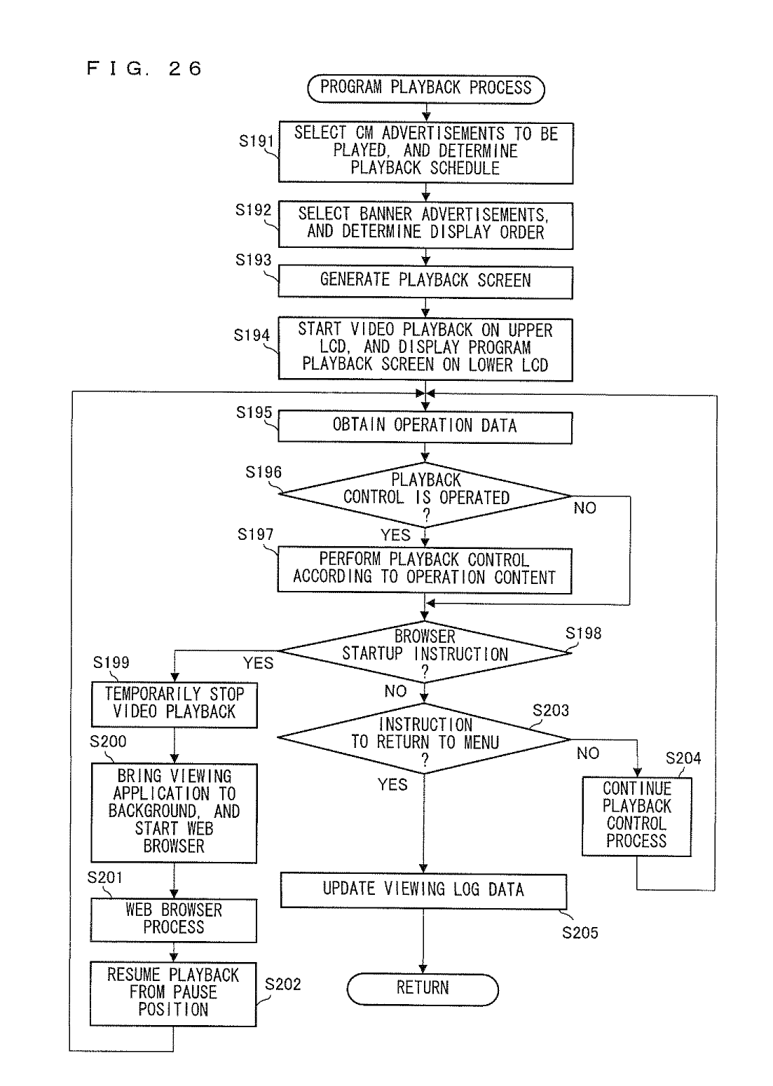

Next, in step S165, the operation data 511 is obtained. Next, in step S166, based on the operation data 511, it is determined whether or not a program playback instruction has been made by the user. As a result of the determination, when a program playback instruction has been made (YES in step S166), in step S167, a program playback process for playing the program for which the playback instruction has been made (referred to as a playback target program, hereinafter) is executed. FIG. 26 is a flowchart illustrating in detail the program playback process. Firstly, in step S191, a process of selecting CM advertisements to be played together with the playback target program is executed. Further, playback positions of the selected CM advertisements (a playback schedule of the selected CM advertisements) during playback of the playback target program are also determined. Although the CM advertisements are basically selected at random, a selection control for preferentially selecting unviewed CM advertisements is simultaneously performed. For example, a selection control for selecting unviewed CM advertisements at random is performed. As for determination of playback positions, a playback position is selected from among three playback positions, “before start of the program”, “after end of the program”, and “during the program”, in the present embodiment. In the case where “during the program” is selected, a playback start position (a position where the CM advertisement is inserted) is designated by a frame number in the program video (for example, the n-th frame from the beginning). For example, if a frame number corresponding to a position of 30 seconds from the start of the program is designated as the start position of a CM advertisement, playback of the program video is temporarily stopped after frames for 30 seconds from the start of the program have been played, and a video of the CM advertisement is played instead of the program video. When playback of the CM video is ended, playback of the program video is resumed from the 31st second frame of the program.

As for the selection of CM advertisements, in an alternative embodiment, CM advertisements may be selected at random regardless of “already viewed” or “unviewed”, without performing a control for preferentially selecting unviewed CM advertisements as described above.

Next, in step S192, selection of banner advertisements to be displayed on the lower LCD 12 during program playback, and determination of display order thereof (a playback schedule of banner advertisements) are performed. Like the selection of CM advertisements, the selection of banner advertisements may be performed such that unviewed banner advertisements are preferentially selected while random selection is basically performed (in an alternative embodiment, completely random selection may be performed). A display time (banner playback time) of each banner advertisement is designated in the banner advertisement metadata 673 of the banner advertisement. Data indicating the playback schedules of the CM advertisements and banner advertisements determined by the above-described process (referred to as playback schedule data, hereinafter) are appropriately stored as temporal data in the main memory 32.

Next, in step S193, a program playback screen as shown in FIG. 6 is generated. That is, a screen, on which a playback control panel 121, a banner advertisement image 122, and the like are arranged, is generated.

Next, in step S194, program playback based on the playback schedule data is started on the upper LCD 22. Further, a process of displaying the screen generated in step S193 on the lower LCD 12 is also executed.

In the present embodiment, there is a possibility that, while communication based on a “task” related to the viewing application, such as a “program reception task”, is performed in the background, an instruction to playback this program might be made. That is, there is a possibility that playback of a program before update and reception of the program after update might occur simultaneously. In this case, in the present embodiment, the system is notified that execution of the “unnoticed communication” should be stopped during playback of the “program”. In response to this notification, the system of the game apparatus 10 temporarily suppresses execution of the process related to the “unnoticed communication”. When the program playback process is ended, a control for resuming execution of the process related to the “unnoticed communication” is performed. In an alternative embodiment, however, a program playback process and a program (or the like) reception process in the background may be executed in parallel with each other, without suppressing execution of the “unnoticed communication”.

Next, in step S195, the operation data 511 is obtained. In the subsequent step S196, it is determined, based on the operation data 511, whether or not an operation for playback control (an operation to the playback control panel 121) has been performed. As a result of the determination, when an operation for playback control has been performed (YES in step S196), in step S197, a playback control process for a program video or a CM advertisement (such as fast-forward or pause) is executed according to the content of the operation. On the other hand, when an operation for playback control has not been performed (NO in step S196), the process of step S197 is skipped.

Next, in step S198, it is determined, based on the operation data 511, whether or not an instruction to start a web browser application (for example, a touch operation to the browser start button 124) has been performed. As a result of the determination, when such an operation has been performed (YES in step S198), in step S199, playback of the program video is temporarily stopped. Next, in step S200, it is notified from the viewing application to the system that a control for starting the web browser application is to be performed with the viewing application being switched to a background process. At this time, the system is also notified of URL information related to the banner advertisement displayed when the browser startup instruction was made. In response to the notification, the system of the game apparatus 10 switches the viewing application to the background process, and starts the web browser application. As a result, in step S201, the web browser process is executed. The web browser application displays a site indicated by the URL information related to the banner advertisement, and executes various processes based on user's operation.

When the process of the web browser application is ended, the system switches the viewing application from the background process to the foreground process. Thereby, the screen of the viewing application is displayed, and the program playback is resumed from the position where the program playback was stopped in step S202. Then, the process returns to step S195, and the same process is repeated.

On the other hand, when the result of the determination in step S198 is that a browser startup instruction has not been made (NO in step S198), it is determined in step S203 whether or not an instruction to return to the menu screen has been made. As a result of the determination, when an instruction to return to the menu screen has not been made (NO in step S203), the playback control process is continued in step S204. That is, based on the playback schedules, programs and the CM advertisements are appropriately played on the upper LCD 22. When the CM advertisements are played, the images of the associated banner advertisements related to the CM advertisements are displayed on the lower LCD 12.

On the other hand, when an instruction to return to the menu screen has been made (YES in step S203), program playback is stopped, and the viewing log data 606 is appropriately updated so as to reflect the playback record at this time (for example, which program has been played and how far the program has been played). Thus, the program playback process is ended.

Referring back to FIG. 25, after the program playback process, the process returns to step S164, and the same process is repeated.

On the other hand, when the result of the determination in step S166 is that the operation content indicated by the operation data 511 is not a program playback instruction (NO in step S166), it is determined in step S168 whether or not an instruction to start “advertisement listing” has been made, i.e., whether or not the advertisement list button 103 has been pressed. As a result of the determination, when the advertisement list button 103 has been pressed (YES in step S168), in step S169, an advertisement listing process is executed.

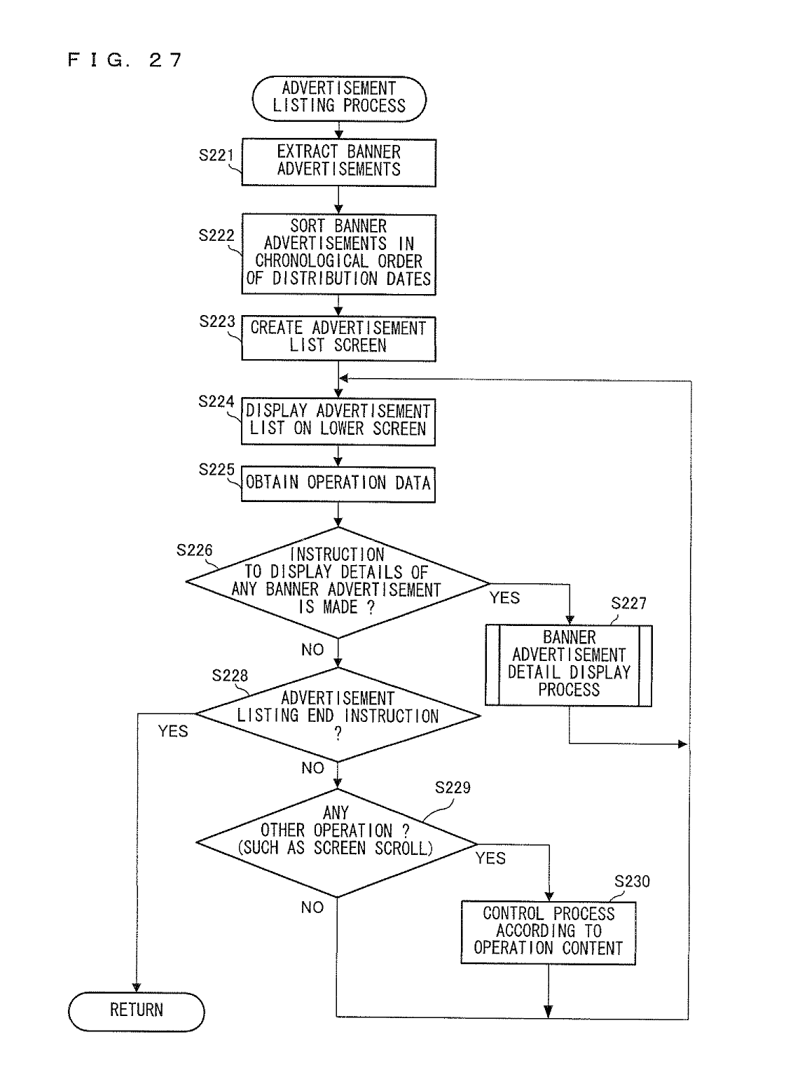

FIG. 27 is a flowchart illustrating in detail the advertisement listing process shown in step S169. Firstly, in step S221, the banner advertisement package 603 is referred to, and extraction of banner advertisements is performed. Further, the CM advertisement package 604 is referred to, and extraction of associated banner advertisements included therein is performed.

Next, in step S222, the extracted banner advertisements are sorted in chronological order of their distribution dates. Then, in step S223, an advertisement list screen as shown in FIG. 7 is generated (banner advertisements of older distribution dates are displayed at the top of the screen). Next, in step S224, the advertisement list screen is displayed on the lower LCD 12.

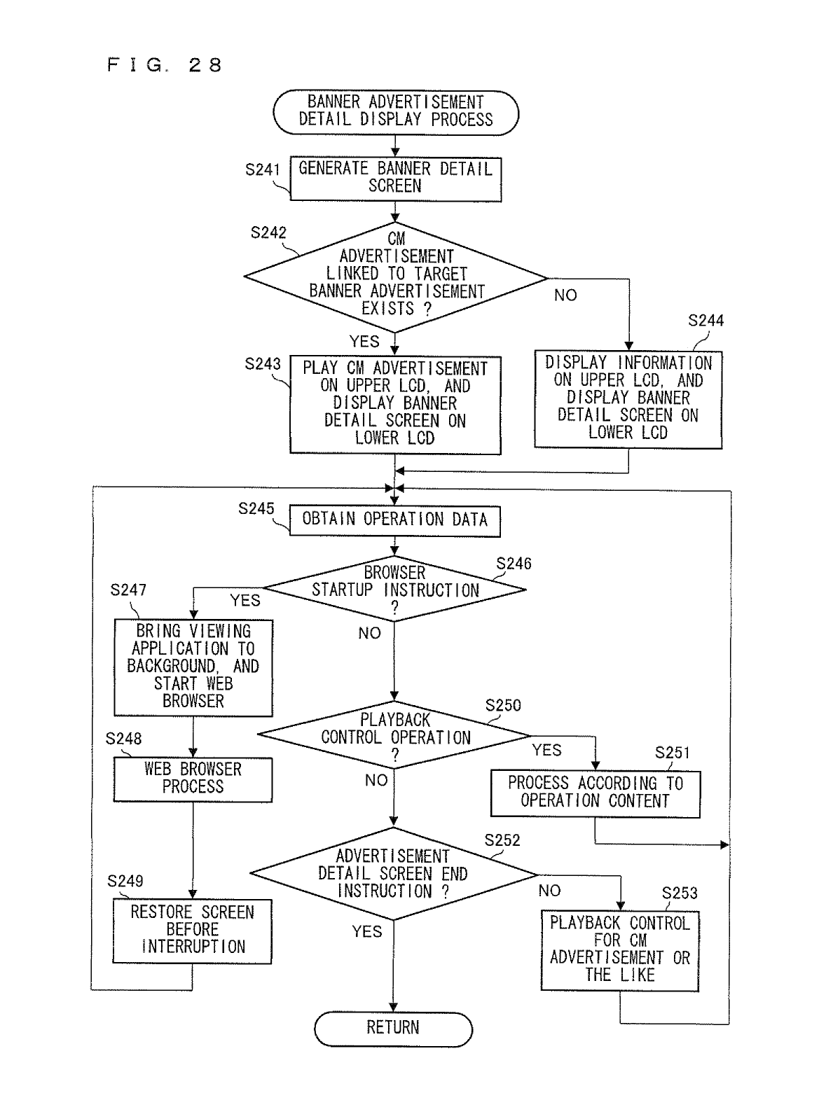

Next, in step S225, the operation data 511 is obtained. Next, in step S226, based on the operation data 511, it is determined whether or not an instruction to display details of any banner advertisement has been made. As a result of the determination, when an instruction to display details of a banner advertisement has been made (YES in step S226), in step S227, a banner advertisement detail display process is executed. FIG. 28 is a flowchart illustrating in detail the banner advertisement detail display process shown in step S227. Initially, in step S241, based on the data of the banner advertisement for which an instruction to display details thereof has been made (referred to as a target banner advertisement, hereinafter), a screen to be displayed on the lower LCD 12 as shown in FIG. 8 is generated.

Next, in step S242, it is determined whether or not there is a CM advertisement linked to the target banner advertisement (that is, whether or not the target banner advertisement is an associated banner advertisement). As a result of the determination, when there is a CM advertisement linked to the target banner advertisement (YES in step S242), in step S243, playback of the linked CM advertisement is started on the upper LCD 22, and a banner advertisement detail screen is displayed on the lower LCD 12. On the other hand, when there is no CM advertisement linked to the target banner advertisement (NO in step S242), in step S244, a variety of information (obtained from the metadata) related to the target banner advertisement are displayed on the upper LCD 22, and the banner advertisement detail screen is displayed on the lower LCD 12.

Next, in step S245, the operation data 511 is obtained. Next, in step S246, based on the operation data 511, it is determined whether or not a web browser application startup instruction has been made. As a result of the determination, when a browser startup instruction has been made (YES in step S246), in step S247, a control for starting the web browser application is performed with the viewing application being switched to a background process. As a result, the system of the game apparatus 10 switches the viewing application to the background process, and starts execution of the web browser application. As a result, in step S248, a web browser process is executed. The web browser application displays a site indicated by the URL information linked to the target banner advertisement, and executes various kinds of processes based on user's operation.

When the web browser application process is ended, the system switches the viewing application from the background process to the foreground process. Thereby, the screen of the viewing application is displayed, and the screen before interruption is restored in step S249. Then, the process returns to step S245, and the same process is repeated.

On the other hand, when the result of the determination in step S246 is that a browser startup instruction has not been made (NO in step S246), it is determined in step S250 whether or not a playback control operation (for example, an instruction to display a next banner advertisement) has been made. As a result, when a playback control operation has been made (YES in step S250), a process according to the content of the operation is appropriately executed. For example, if an instruction to display another banner advertisement has been made, a process of displaying an image of a next banner advertisement is performed. At this time, it is determined whether or not a CM advertisement linked to the banner advertisement is present, and the content to be displayed on the upper LCD 22 is appropriately varied according to a result of the determination. Thereafter, the process returns to step S245, and the same process is repeated.

On the other hand, when the result of the determination in step S250 is that the operation content is not playback control (NO in step S250), it is determined in step S252 whether or not an instruction to end the detail display process has been made (for example, whether or not the return button 142 is pressed). As a result of the determination, when such an end instruction has not been made (NO in step S252), in step S253, a CM advertisement playback control process, a screen rendering process, or the like is executed. Thereafter, the process returns to step S245, and the same process is repeated. On the other hand, when an end instruction has been made (YES in step S252), the banner advertisement detail display process is ended.

Referring back to FIG. 27, when the result of the determination in step S226 is that a banner advertisement detail display instruction has not been made (NO in step S266), it is determined in step S228 whether or not an instruction to end the advertisement listing process has been made. For example, it is determined whether or not the return button 132 has been pressed. As a result of the determination, when such an end instruction has been made (YES in step S228), the advertisement listing process is ended. On the other hand, when such an end instruction has not been made (NO in step S228), it is determined in step S229 whether or not another operation has been made. For example, it is determined whether or not a screen scroll operation has been made. When another operation has been made (YES in step S229), in step S230, a process according to the content of the operation is executed. Thereafter, the process returns to step S224, and the same process is repeated. On the other hand, when another operation has not been made (NO in step S229), the process returns to step S224, and the same process is repeated. In the present embodiment, the viewing record of each advertisement viewed in the advertisement listing process is not reflected to the viewing log data 606. However, in an alternative embodiment, it may be reflected to the viewing log data 606. This is the end of the description of the advertisement listing process.

Referring back to FIG. 25, after the advertisement listing process, the process returns to step S164, and the same process is repeated. On the other hand, when the result of the determination in step S168 is that an instruction to start “advertisement listing” has not been made (NO in step S168), it is determined in step S170 whether or not a setting screen startup instruction has been made. As a result of the determination, when a setting screen startup instruction has been made (YES in step S170), a setting screen process is executed in step S171. In this process, a setting screen related to the viewing application is displayed, and a process of perfoiining various settings based on user's operation is executed. Thereafter, the process returns to step S164, and the same process is repeated.

On the other hand, when the result of the determination in step S170 is that a setting screen startup instruction has not been performed (NO in step S170), it is determined in step S172 whether or not a viewing application end instruction has been made. When such an end instruction has not been made (NO in step S172), the process returns to step S164, and the same process is repeated. At this time, if the user's operation indicated by the operation data is pressing the immediate update button 102, the “reception tasks” of “programs” and “advertisements” are immediately executed. Then, it is displayed on the screen that the program and advertisement data are being immediately updated, and the process returns to step S164 after the immediate update process is completed.

On the other hand, when the result of the determination in step S172 is that an end instruction has been made (YES in step S172), the main process is ended.

Referring back to FIG. 22, after completion of the main process, a “viewing log transmission task” preparation process is executed in step S106. Specifically, a process of registering in the system or updating the “viewing log transmission task” is executed. In the present embodiment, in principle, the “task” is registered such that “1” is set as the number of uses of the “task”. That is, the viewing log data 606 is basically transmitted only once after end of the viewing application, and updated with the number of uses being set to “1”, every time the viewing application is started and ended. As a result, when the transmission task is executed, the viewing log data 606 is transmitted to a predetermined server. Thus, the viewing application process is ended.

As described above, in the present embodiment, data constituting “programs” and data constituting “advertisements” are separately received and treated as different files. Thereby, the amount of data required for one reception process is reduced and thus the communication load on the network is reduced, as compared to the case where data of “programs” and data of “advertisements” are integrated to be transmitted or received. In other words, the processing burden on the reception of programs and advertisements can be dispersed. Further, for example, in a hand-held information terminal which performs data transmission/reception with a predetermined server via a public wireless LAN access point (typically, an information terminal having only a short-distance wireless communication function), so-called constant connection to the network is not ensured. However, since the present invention realizes a reduction in the amount of data per reception process, it is suitable for the case where distribution of programs and CMs is performed in such an information terminal.

Further, since “advertisements” and “programs” are separately received, it is possible to use the same “advertisement” in a plurality of programs. Therefore, in an embodiment where a common advertisement is shared by a plurality of programs, a waste of data due to redundant distribution of the same advertisement can be avoided, in contrast to the case where programs and advertisements are integrated and distributed.

Further, according to the “unnoticed communication”, reception of “programs” or the like is performed even when the user does not use the game apparatus 10 (sleep mode). Therefore, the programs or the like, which have been distributed before the user knows, can surprise and please the user.

Further, concerning the schedules of automatic reception of “programs” and “advertisements” by the “unnoticed communication”, since the schedules can be set individually for “programs” and “advertisements”, the load on the reception process can be appropriately dispersed. Further, since these schedules can be changed by using the setting package 605, more flexible program/advertisement distribution can be achieved.

Further, since one “reception task” is assigned to each “program” of each TV station, each program can be individually received according to the content of the program, the creator thereof, and the like. Furthermore, the reception schedule thereof can be individually set.

Further, when viewing software is executed, a control for preferentially playing unviewed programs or advertisements is performed. Therefore, a variety of programs created by the program providers are provided with equal opportunities to attract the user's (viewer's) attention.

Further, when playing programs, a control for equally playing the programs supplied from the respective TV stations is performed. Therefore, provision of programs from the TV stations can be promoted.

While in the above-described embodiment, CM advertisements are not included in the program package. In an alternative embodiment, CM advertisements may be included in the program package. When playing a certain program, a CM advertisement to be inserted in the middle of the program may be selected from among the CM advertisements in the program package and played. In this case, while the program itself is being played, a banner advertisement image selected at random from the banner advertisement package 603 may be displayed. Alternatively, banner advertisements may also be included in the program package, and only a banner advertisement selected from among the banner advertisements may be displayed.

Concerning output of a viewing history, in the above-described embodiment, the viewing log data 606 is updated after the program playback process is completed. Alternatively, at a timing when playback of a program is started, this program may be regarded as having been viewed, and the viewing log data 606 may be updated.

In the above-described embodiment, when the viewing application is started, if unviewed programs are present, the unviewed programs are automatically played. Concerning this playback, the menu screen may be displayed after one unviewed program has been played, or a plurality of unviewed programs may be continuously automatically played until the user performs an operation to stop the playback. When a plurality of unviewed programs are continuously automatically played, the playback should be controlled such that the programs of the respective TV stations are alternately played (in the case of two TV stations), or the programs of the respective TV stations are played in order to avoid a situation that programs of the same TV station are continuously played (in the case of three or more TV stations). For example, when there are three TV stations A, B, and C, program playback should be performed in order of “station A→station B→station C→station A→station B→station C . . . ” so as to repeat a cycle in which a program of each station is played once. Thereby, it is possible to avoid a situation that unviewed programs of a certain TV station are dominantly automatically played (unfair number of times of playback). Thus, inequality is prevented from occurring between the TV stations.

Further, concerning determination of the playback order, in the above-described embodiment, the playback order is determined by the process of using the startup time of the viewing application. However, the playback order may be determined by another method. For example, the TV station of a program which has been automatically played last may be recorded, and a program of a TV station other than this TV station may be selected as a program to be played next. Alternatively, a predetermined playback order may be defined among the TV stations, and programs of the respective TV stations may be successively played in accordance with the playback order.

Further, concerning automatic playback when the viewing application is started, a program that the user views very often may be preferentially automatically played with reference to the viewing history data. Moreover, a time zone in which each program was played may be calculated based on the viewing history data, and a program according to a time zone when the viewing application is started may be automatically played. For example, when the viewing application is started at 7 o'clock in the morning, a news program may be automatically played.

Further, when the viewing application is started, a program selected at random, regardless of whether it is unviewed or not, may be automatically played.

While in the above-described embodiment, the game apparatus 10 having two display devices has been described. However, a hand-held terminal having a single display device, and a touch panel on a screen of the display device is also within the scope of the present invention. In this case, for example, a screen layout may be performed such that left ⅔ is assigned to an area for program playback, and remaining ⅓ is assigned to an area for banner advertisement display.

### INDUSTRIAL APPLICABILITY

An information processing apparatus according to the present invention is capable of receiving distributed various kinds of programs and advertisements while reducing the load on the network, and is applicable to a hand-held information processing terminal and the like.

While the invention has been described in detail, the foregoing description is in all aspects illustrative and not restrictive. It will be understood that numerous other modifications and variations can be devised without departing from the scope of the invention.

What is claimed is:

1. An information processing apparatus comprising:
task setting means for setting a program reception task and an advertisement reception task, the program reception task defining an execution content which includes an execution schedule of a reception process for program data including video data and audio data of programs, and the advertisement reception task defining an execution content which includes an execution schedule of a reception process for advertisement data including at least one of video data, still image data, and audio data of advertisements;
connection means for connecting the information processing apparatus to a server; and
task execution means for executing the program reception task and the advertisement reception task, based on the execution schedules which are set in the program reception task and the advertisement reception task, respectively, thereby executing reception of the program data and reception of the advertisement data from the server independently from each other.

2. The information processing apparatus according to claim 1, wherein
each of the execution schedules includes at least one of the execution interval of the reception process, the priority thereof, and the number of times thereof, and
the execution schedule of the program reception task and the execution schedule of the advertisement reception task are different from each other.

3. The information processing apparatus according to claim 1, wherein
the task setting means sets an update task which represents an execution schedule of a reception process for update data for updating the execution schedules of the program reception task and the advertisement reception task, and
the task execution means executes the update task to update the execution schedule of at least one of the program reception task, the advertisement reception task, and the update task, based on the update data received from the server.

4. The information processing apparatus according to claim 1, wherein
the task setting means sets a plurality of program reception tasks, and
the task execution means executes the plurality of program reception tasks to perform receptions of a plurality of program data independently from each other.

5. The information processing apparatus according to claim 1 further including:
application execution means for executing an application for playing the program data, wherein
the application execution means, when executing the application, automatically plays the program data received by the task execution means.

6. The information processing apparatus according to claim 5 further including:
program playback information setting means for setting program playback information indicating whether or not there is a playback record of the program data, wherein
the application execution means, when executing the application, automatically plays the program data which is indicated as being unplayed by the program playback information.

7. The information processing apparatus according to claim 5, wherein
the task setting means sets a plurality of program reception tasks corresponding to program data provided from a plurality of creators,
the task execution means executes the plurality of program reception tasks to independently perform receptions of the plurality of program data provided from the plurality of creators, and
when there are a plurality of program data created by a plurality of creators, which are indicated as being unplayed by the program playback information, the application execution means automatically plays the plurality of unplayed program data in accordance with a predetermined order.

8. The information processing apparatus according to claim 7 further including:
counting means for counting a time;
application startup time obtaining means for obtaining a startup time when the application is executed; and
order determination means for determining program data of a creator, which is to be played first in the predetermined order, based on the time obtained by the application startup time obtaining means.

9. The information processing apparatus according to claim 7, wherein the order determination means determines the predetermined order such that two or more programs from the same creator are not played continuously.

10. The information processing apparatus according to claim 5, wherein
the application execution means outputs, to a display section, a program video based on the program data and an advertisement based on the advertisement data, and
the information processing apparatus further includes:
viewing information creation means for creating viewing record information indicating a viewing record of the program and a viewing record of the advertisement, in response to that the program and the advertisement are outputted to the display section; and
viewing information transmission means for transmitting, to the server, the viewing record information created by the viewing information creation means.

11. The infornation processing apparatus according to claim 5, wherein
the task execution means executes the advertisement reception task to receive a plurality of advertisement data from the server,
the application execution means plays the program data, and displays, on a predetermined display section, advertisements based on the advertisement data, and
the information processing apparatus further includes advertisement selection means for selecting, based on predetermined conditions, the advertisements to be displayed on the display section.

12. The information processing apparatus according to claim 11, wherein the advertisement selection means selects at random advertisements to be displayed on the display section.

13. The information processing apparatus according to claim 11 further including:
advertisement playback information setting means for setting advertisement playback information indicating whether or not there is a playback record of the advertisement data, wherein
the advertisement selection means selects advertisements to be displayed on the display section from among advertisements which are indicated as being unplayed by the advertisement playback information.

14. The information processing apparatus according to claim 11 further including:
input reception means for receiving an input from a user;
instruction determination means for determining, based on the input received by the input reception means, whether or not the user designates an advertisement displayed on the display section based on the still image data; and
web site connection means for connecting the information processing apparatus to a web site linked to the still image data, when the instruction determination means determines that the user designates an advertisement.

15. The information processing apparatus according to claim 5, wherein
the task execution means automatically executes the program reception task and the advertisement reception task as background processes, and
the application execution means executes the application for playing the program data, as a foreground process, in accordance with user's instruction, and automatically outputs, when it is started, the program data and the advertisement data which have been received in the background by the task execution means.

16. The information processing apparatus according to claim 1, wherein
the information processing apparatus is a hand-held information processing terminal, and further includes searching means for automatically and repeatedly searching for a predetermined access point by using short-distance wireless communication, and
when the searching means detects the access point, the connection means automatically connects the information processing apparatus to the server via the access point.

17. The information processing apparatus according to claim 2, wherein
the task setting means sets the execution schedules such that the execution interval of the advertisement reception task is shorter than that of the program reception task, the priority of the advertisement reception task is higher than that of the program reception task, and the number of times of execution of the advertisement reception task is greater than that of the program reception task.

18. A computer-readable storage medium having stored therein an information processing program that is executed by a computer of an information processing apparatus, wherein
the information processing program causes the computer to function as:
task setting means for setting a program reception task and an advertisement reception task, the program reception task defining an execution content which includes an execution schedule of a reception process for program data including video data and audio data of programs, and the advertisement reception task defining an execution content which includes an execution schedule of a reception process for advertisement data including at least one of video data, still image data, and audio data of advertisements;
connection means for connecting the information processing apparatus to a server; and
task execution means for executing the program reception task and the advertisement reception task, based on the execution schedules which are set in the program reception task and the advertisement reception task, respectively, thereby executing reception of the program data and reception of the advertisement data from the server independently from each other.

19. An information processing method executed by an information processing apparatus, the method comprising:
a task setting step of setting a program reception task and an advertisement reception task, the program reception task defining an execution content which includes an execution schedule of a reception process for program data including video data and audio data of programs, and the advertisement reception task defining an execution content which includes an execution schedule of a reception process for advertisement data including at least one of video data, still image data, and audio data of advertisements;
a connection step of connecting the information processing apparatus to a server; and
a task execution step of executing the program reception task and the advertisement reception task, based on the execution schedules which are set in the program reception task and the advertisement reception task, respectively, thereby executing reception of the program data and reception of the advertisement data from the server independently from each other.

20. An information processing system constituted of a server and at least one information processing apparatus, wherein
the server includes transmission means capable of transmitting program data and advertisement data independently from each other, the program data including video data and audio data of a program, and the advertisement data including at least one of video data, still image data, and audio data of an advertisement, and
the information processing apparatus includes:
task setting means for setting a program reception task and an advertisement reception task, the program reception task defining an execution content which includes an execution schedule of a reception process for the program data, and the advertisement reception task defining an execution content including an execution schedule of a reception process for the advertisement data;
connection means for connecting the information processing apparatus to a server; and
task execution means for executing the program reception task and the advertisement reception task, based on the execution schedules which are set in the program reception task and the advertisement reception task, respectively, thereby executing reception of the program data and reception of the advertisement data from the server independently from each other.
